(19) United States
(12) Patent Application Publication
(10) Pub. No.: US 2011/0311879 A1
(43) Pub. Date: Dec. 22, 2011

(54) NONAQUEOUS ELECTROLYTE AND NONAQUEOUS ELECTROLYTE BATTERY

(75) Inventors: Ichiro Yamada, Fukushima (JP); Shunsuke Saito, Fukushima (JP); Haruo Watanabe, Kanagawa (JP); Tadahiko Kubota, Kanagawa (JP)

(73) Assignee: SONY CORPORATION, Tokyo (JP)

(21) Appl. No.: 13/155,579

(22) Filed: Jun. 8, 2011

(30) Foreign Application Priority Data
Jun. 17, 2010 (JP) 2010-138368

(51) Int. Cl. H01M 10/056

(52) U.S. Cl. 429/303; 429/324; 429/325

(57) ABSTRACT

A nonaqueous electrolyte includes: a solvent; an electrolyte salt; an aromatic compound represented by the following formula (1); and a polyoxometalate and/or a polyoxometalate compound

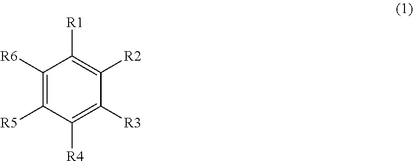

wherein each of R1 to R6 independently represents a hydrogen group, a halogen group, an aliphatic alkyl group, an alicyclic alkyl group, a phenyl group or an alkoxy group; at least one of R1 to R6 is a halogen group, an aliphatic alkyl group, an alicyclic alkyl group, a phenyl group or an alkoxy group; a part or all of hydrogens of R1 to R6 may be substituted with a halogen; and at least a part of R1 to R6 may be bonded to each other to form a ring.

### CROSS REFERENCES TO RELATED APPLICATIONS

The present application claims priority to Japanese Priority Patent Application JP 2010-138368 filed in the Japan Patent Office on Jun. 17, 2010, the entire contents of which is hereby incorporated by reference.

### BACKGROUND

The present application relates to a nonaqueous electrolyte and a nonaqueous electrolyte battery. In more detail, the present application relates to a nonaqueous electrolyte containing an organic solvent and an electrolyte salt and a nonaqueous electrolyte battery using the same.

In recent years, portable electronic appliances such as a video camera, a mobile phone and a laptop personal computer have widely spread, and it is strongly demanded to realize downsizing, weight reduction and long life thereof. Following this, the development of batteries as a power source for portable electronic appliances, in particular, secondary batteries which are lightweight and from which a high energy density is obtainable is advanced.

Above all, secondary batteries utilizing intercalation and deintercalation of lithium for a charge/discharge reaction (so-called lithium ion secondary batteries) are largely expected because a high energy density is obtainable as compared with lead batteries and nickel-cadmium batteries.

Such a lithium ion secondary battery is provided with an electrolytic solution containing a solvent and an electrolyte salt dissolved in this solvent. As this solvent, mixed solvents obtained by mixing a high-dielectric constant solvent which is easy to solvate with the electrolyte salt (for example, ethylene carbonate, propylene carbonate, etc.) and a low-viscosity solvent with excellent ion conductivity (for example, diethyl carbonate, dimethyl carbonate, ethyl methyl carbonate, etc.) are widely used. However, when a potential of a positive/negative electrode is increased, a high-potential positive electrode active material or negative electrode active material and a nonaqueous electrolyte react with each other to cause decomposition, or cobalt contained in the positive electrode active material elutes. Thus, there was involved such a problem that battery characteristics are lowered.

Since the characteristics of the lithium ion secondary battery are largely influenced by a nonaqueous electrolytic solution to be used, for the purpose of more enhancing the battery characteristics, there are proposed nonaqueous electrolytic solutions containing various compounds. For example, JP-A-10-275632 proposes a technology using an electrolytic solution containing a nonionic aromatic compound for the purpose of suppressing the reaction between the electrode and the electrolytic solution at a high temperature. As this nonionic aromatic compound, an alkyl group-containing aromatic compound or an alkoxy group-containing aromatic compound is used. According to this technology, the nonionic aromatic compound added to the electrolytic solution adsorbs on the surface of the negative electrode to suppress the direct contact with the surface of the negative electrode, whereby the battery characteristics are improved.

In order to prevent a decomposition reaction of an aromatic compound to be caused when stored at a high temperature, JP-A-2008-153096 proposes a technology for using a cyclic carbonate having two or more halogens as constituent elements (reactive cyclic carbonate) jointly with the aromatic compound. This cyclic carbonate having halogens as constituent elements forms a coating called “SEI” (solid electrolyte interface) on a negative electrode at the time of charge/discharge at the beginning of use of a battery, thereby suppressing the decomposition reaction on the negative electrode.

### SUMMARY

However, there was involved such a problem that though the reactive cyclic carbonate is able to form stiff SEI, it raises the resistance of an electrode surface. In particular, there was involved such a problem that as to the discharge capacity in the case of repeating charge/discharge, the battery characteristics are not sufficient. Also, since the aromatic compound is a compound having a high decomposition potential, while it is excellent on the point of suppressing a side reaction on the positive electrode, it is easy to cause a decomposition reaction on the negative electrode. Thus, it was difficult to obtain sufficient battery characteristics.

Thus, it is desirable to provide a nonaqueous electrolyte and a nonaqueous electrolyte battery, each of which is able to improve high-temperature cycle characteristic and battery characteristics after high-temperature storage.

One embodiment is directed to a nonaqueous electrolyte containing a solvent, an electrolyte salt, an aromatic compound represented by the following formula (1) and a polyoxometalate and/or a polyoxometalate compound.

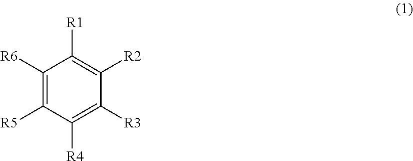

In the formula (1), each of R1 to R6 independently represents a hydrogen group, a halogen group, an aliphatic alkyl group, an alicyclic alkyl group, a phenyl group or an alkoxy group;

at least one of R1 to R6 is a halogen group, an aliphatic alkyl group, an alicyclic alkyl group, a phenyl group or an alkoxy group;

a part or all of hydrogens of R1 to R6 may be substituted with a halogen; and

at least a part of R1 to R6 may be bonded to each other to form a ring.

Another embodiment is directed to a nonaqueous electrolyte battery including a positive electrode, a negative electrode and a nonaqueous electrolyte containing a solvent and an electrolyte salt, wherein the nonaqueous electrolyte contains an aromatic compound represented by the following formula (1), and a coating in a gel form containing an amorphous polyoxometalate and/or polyoxometalate compound having one or more addenda atoms is formed on the negative electrode.

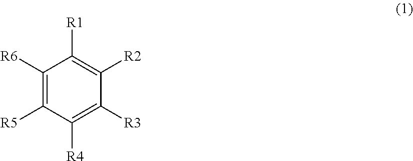

In the formula (1), each of R1 to R6 independently represents a hydrogen group, a halogen group, an aliphatic alkyl group, an alicyclic alkyl group, a phenyl group or an alkoxy group;

at least one of R1 to R6 is a halogen group, an aliphatic alkyl group, an alicyclic alkyl group, a phenyl group or an alkoxy group;

a part or all of hydrogens of R1 to R6 may be substituted with a halogen; and

at least a part of R1 to R6 may be bonded to each other to form a ring.

Still another embodiment is directed to a nonaqueous electrolyte battery including a positive electrode, a negative electrode and a nonaqueous electrolyte, wherein the nonaqueous electrolyte contains a solvent, an electrolyte salt, a polyoxometalate and/or a polyoxometalate compound and an aromatic compound represented by the following formula (1).

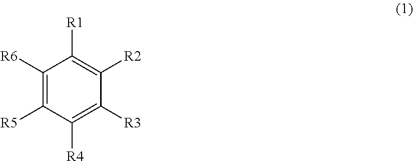

In the formula (1), each of R1 to R6 independently represents a hydrogen group, a halogen group, an aliphatic alkyl group, an alicyclic alkyl group, a phenyl group or an alkoxy group;

at least one of R1 to R6 is a halogen group, an aliphatic alkyl group, an alicyclic alkyl group, a phenyl group or an alkoxy group;

a part or all of hydrogens of R1 to R6 may be substituted with a halogen; and

at least a part of R1 to R6 may be bonded to each other to form a ring.

According to the one and still another embodiments of the present application, a coating derived from the cluster of oxoacid and/or the cluster of oxoacidic compound contained in the nonaqueous electrolyte is formed on the surface of the negative electrode due to charge/discharge. According to this, the decomposition of the solvent, the electrolyte salt and the aromatic compound represented by the formula (1), all of which are contained in the nonaqueous electrolyte, is suppressed. Also, in view of the fact that the decomposition of the aromatic compound represented by the formula (1), which is contained in the nonaqueous electrolyte, is suppressed, properties of suppressing the side reaction on the positive electrode, which the aromatic compound represented by the formula (1) has, can be sufficiently revealed on the positive electrode.

According to the another embodiment, the coating in a gel form containing the amorphous cluster of oxoacid and/or cluster of oxoacidic compound having one or more addenda atoms is formed on the negative electrode. According to this, the decomposition of the solvent, the electrolyte salt and the aromatic compound represented by the formula (1), all of which are contained in the nonaqueous electrolyte, is suppressed. Also, in view of the fact that the decomposition of the aromatic compound represented by the formula (1), which is contained in the nonaqueous electrolyte, is suppressed, properties of suppressing the side reaction on the positive electrode, which the aromatic compound represented by the formula (1) has, can be sufficiently revealed on the positive electrode.

According to the embodiments of the present application, the high-temperature cycle characteristic and the battery characteristics after high-temperature storage can be improved.

Additional features and advantages are described herein, and will be apparent from the following Detailed Description and the figures.

### BRIEF DESCRIPTION OF THE FIGURES

FIG. 1 is a sectional view showing a configuration example of a nonaqueous electrolyte battery according to an embodiment.

FIG. 2 is a sectional view showing enlargedly a part of a wound electrode body in FIG. 1.

FIG. 3 is an SEM photograph of a negative electrode surface according to the present application.

FIG. 4 is an example of a secondary ion spectrum by the time-of-flight secondary ion mass spectrometry (ToF-SIMS) on a negative electrode surface having a deposit deposited thereon by the addition of silicotungstic acid into a battery system.

FIG. 5 is an example of a radial structure function of a W—O bond obtained by the Fourier transformation of a spectrum by the X-ray absorption fine structure (XAFS) analysis on a negative electrode surface having a deposit deposited thereon by the addition of silicotungstic acid into a battery system.

FIG. 6 is an exploded perspective view showing a configuration example of a nonaqueous electrolyte battery according to an embodiment.

FIG. 7 is a sectional view along an I-I line of a wound electrode body in FIG. 6.

FIG. 8 is an exploded perspective view showing an example of a configuration of a nonaqueous electrolyte battery according to an embodiment.

FIG. 9 is a perspective view showing an example of an appearance of a battery device.

FIG. 10 is a sectional view showing an example of a configuration of a battery device.

FIG. 11 is a plan view showing an example of a shape of a positive electrode.

FIG. 12 is a plan view showing an example of a shape of a negative electrode.

FIG. 13 is a plan view showing an example of a shape of a separator.

FIG. 14 is a sectional view showing an example of a configuration of a battery device which is used for a nonaqueous electrolyte battery according an embodiment.

### DETAILED DESCRIPTION

Embodiments of the present application will be described below in detail with reference to the drawings.

The description is made in the following order.

1. First embodiment (an electrolytic solution)

2. Second embodiment (a first example of a nonaqueous electrolyte battery)

3. Third embodiment (a second example of a nonaqueous electrolyte battery)

4. Fourth embodiment (a third example of a nonaqueous electrolyte battery)

5. Fifth embodiment (a fourth example of a nonaqueous electrolyte battery)

6. Sixth embodiment (a fifth example of a nonaqueous electrolyte battery)

7. Other embodiments (modification examples)

### 1. First Embodiment

Electrolytic Solution

An electrolytic solution according to a first embodiment is described. The electrolytic solution according to the first embodiment is, for example, one which is used for electrochemical devices such as batteries. The electrolytic solution contains a solvent, an electrolyte salt, a heteropolyacid and/or a heteropolyacid compound and an aromatic compound represented by the following formula (1).

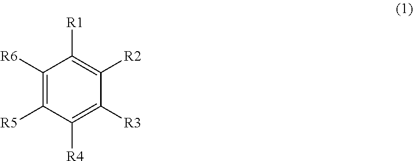

In the formula (1), each of R1 to R6 independently represents a hydrogen group, a halogen group, an aliphatic alkyl group, an alicyclic alkyl group, a phenyl group or an alkoxy group;

at least one of R1 to R6 is a halogen group, an aliphatic alkyl group, an alicyclic alkyl group, a phenyl group or an alkoxy group;

a part or all of hydrogens of R1 to R6 may be substituted with a halogen; and

at least a part of R1 to R6 may be bonded to each other to form a ring.

Solvent

Examples of the solvent which can be used include ethylene carbonate (EC), propylene carbonate (PC), butylene carbonate, dimethyl carbonate, diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate and dimethyl sulfoxide. This is because in the case of using this electrolytic solution for electrochemical devices such as batteries, excellent capacity, cycle characteristic and storage characteristic are obtainable. These materials may be used singly or in admixture of plural kinds thereof.

Above all, it is preferable to use one containing, as the solvent, at least one member selected from the group consisting of ethylene carbonate, propylene carbonate, dimethyl carbonate, diethyl carbonate and ethyl methyl carbonate. This is because sufficient effects are obtainable. In that case, in particular, it is preferable to use one containing a mixture of ethylene carbonate or propylene carbonate, each of which is a high viscosity (high dielectric constant) solvent (for example, specific dielectric constant ∈≧30), and dimethyl carbonate, diethyl carbonate or ethyl methyl carbonate, each of which is a low viscosity solvent (for example, viscosity≦1 mPa·s). This is because dissociation properties of the electrolyte salt and mobility of ions are enhanced, so that higher effects are obtainable.

Electrolyte Salt

The electrolyte salt may, for example, contain one or two or more kinds of a light metal salt such as a lithium salt. Examples of this lithium salt include lithium hexafluorophosphate (LiPF6), lithium tetrafluoroborate (LiBF4), lithium perchlorate (LiClO4), lithium hexafluoroarsenate (LiAsF6), lithium tetraphenylborate (LiB(C6H5)4), lithium methanesulfonate (LiCH3 SO3), lithium trifluoromethanesulfonate (LiCF3 SO3), lithium tetrachloroaluminate (LiAlCl4), dilithium hexafluorosilicate (Li2SiF6), lithium chloride (LiCl) and lithium bromide (LiBr). Above all, at least one member selected from the group consisting of lithium hexafluorophosphate, lithium tetrafluoroborate, lithium perchlorate and lithium hexafluoroarsenate is preferable, and lithium hexafluorophosphate is more preferable. This is because the resistance of the electrolytic solution is lowered. In particular, it is preferable to use lithium tetrafluoroborate together with lithium hexafluorophosphate.

It is preferable that this electrolytic solution contains at least one member of compounds selected from the group consisting of unsaturated cyclic carbonates and halogenated cyclic carbonates. This is because the chemical stability of the electrolytic solution is more enhanced.

Examples of the unsaturated cyclic carbonate include vinylene carbonate based compounds, vinyl ethylene carbonate based compounds and methylene ethylene based carbonate based compounds. Examples of the vinylene carbonate based compound include vinylene carbonate, methyl vinylene carbonate, ethyl vinylene carbonate, 4,5-dimethyl-1,3-dioxol-2-one and 4,5-diethyl-1,3-dioxol-2-one; examples of the vinyl ethylene carbonate based compound include vinyl ethylene carbonate, 4-methyl-4-vinyl-1,3-dioxolan-2-one, 4-ethyl-4-vinyl-1,3-dioxolan-2-one, 5-methyl-4-vinyl-1,3-dioxolan-2-one and 4,5-divinyl-1,3-dioxolan-2-one; and examples of the methylene ethylene carbonate based compound include 4-methylene-1,3-dioxolan-2-one and 4,4-dimethyl-5-methylene-1,3-dioxolan-2-one. These materials may be used singly or in admixture of plural kinds thereof.

Examples of the halogenated cyclic carbonate include 4-fluoro-1,3-dioxolan-2-one, 4-chloro-1,3-dioxolan-2-one, 4,5-difluoro-1,3-dioxolan-2-one, tetrafluoro-1,3-dioxolan-2-one, 4-chloro-5-fluoro-1,3-dioxolan-2-one, 4,5-dichloro-1,3-dioxolan-2-one, tetrachloro-1,3-dioxolan-2-one, 4,5-bistrifluoromethyl-1,3-dioxolan-2-one, 4-trifluoromethyl-1,3-dioxolan-2-one, 4,5-difluoro-4,5-dimethyl-1,3-dioxolan-2-one, 4,4-difluoro-5-methyl-1,3-dioxolan-2-one, 4-ethyl-5,5-difluoro-1,3-dioxolan-2-one, 4-fluoro-5-trifluoromethyl-1,3-dioxolan-2-one, 4-methyl-5-trifluoromethyl-1,3-dioxolan-2-one, 4-fluoro-4,5-dimethyl-1,3-di oxolan-2-one, 5-(1,1-difluoroethyl)-4,4-difluoro-1,3-dioxolan-2-one, 4,5-dichloro-4,5-dimethyl-1,3-dioxolan-2-one, 4-ethyl-5-fluoro-1,3-dioxolan-2-one, 4-ethyl-4,5-difluoro-1,3-dioxolan-2-one, 4-ethyl-4,5,5-trifluoro-1,3-dioxolan-2-one and 4-fluoro-4-methyl-1,3-dioxolan-2-one. These materials may be used singly or in admixture of plural kinds thereof.

For example, a material obtained by mixing an unsaturated cyclic carbonate and/or a cyclic carbonate together with a saturated cyclic carbonate such as ethylene carbonate and a chain carbonate such as dimethyl carbonate is used as the electrolytic solution. At that time, a content of the saturated cyclic carbonate is, for example, 10% by mass or more and not more than 50% by mass. A content of the chain carbonate is, for example, 30% by mass or more and not more than 80% by mass. A content of the unsaturated cyclic carbonate and/or the cyclic carbonate is, for example, 0.01% by mass or more and not more than 30% by mass.

Heteropolyacid and/or Heteropolyacid Compound

The heteropolyacid and/or the heteropolyacid compound is a condensate of two or more kinds of an oxoacid. It is preferable that this heteropolyacid or heteropolyacid compound has a structure in which a heteropolyacid ion thereof is easily soluble in the solvent of the battery, such as a Keggin structure, an Anderson structure, a Dawson structure and a Preyssler structure.

Examples of the heteropolyacid and/or the heteropolyacid compound include heteropolyacids and/or heteropolyacid compounds having a addenda atom selected from the following element group (a); and heteropolyacids and/or heteropolyacid compounds having a addenda atom selected from the following element group (a), in which a part of the addenda atoms is substituted with at least any one element selected from the following element group (b).

Element group (a): Mo, W, Nb, V

Element group (b): Ti, Cr, Mn, Fe, Co, Ni, Cu, Zn, Ga, Zr, Tc, Rh, Cd, In, Sn, Ta, Re, Tl, Pb

Also, examples of the heteropolyacid and/or the heteropolyacid compound include heteropolyacids and/or heteropolyacid compounds having a hetero atom selected from the following element group (c); and heteropolyacids and/or heteropolyacid compounds having a hetero atom selected from the following element group (c), in which a part of the hetero atoms is substituted with at least any one element selected from the following element group (d).

Element group (c): B, Al, Si, P, Cr, Mn, Fe, Co, Ni, Cu, Zn, Ge, As

Element group (d): H, Be, B, C, Na, Al, Si, P, S, Ti, V, Cr, Mn, Fe, Co, Ni, Cu, Zn, Ga, Ge, As, Se, Zr, Rh, Sn, Sb, Te, I, Re, Pt, Bi, Ce, Th, U, Np

Examples of the heteropolyacid and/or the heteropolyacid compound include heteropolyacids and/or heteropolyacid compounds represented by any one of the following formulae (A) to (D).

Anderson structure: HₓA_{y}[BD₆O₂₄].zH₂O Formula (A)

In the formula (A), x, y and z are values falling within the ranges of (0≦x≦8), (0≦y≦8) and (0≦z≦50), respectively, provided that at least one of x and y is not 0.

Keggin structure: HₓA_{y}[BD₁₂O₄₀].zH₂O Formula (B)

In the formula (B), x, y and z are values falling within the ranges of (0≦x≦4), (0≦y≦4) and (0≦z≦50), respectively, provided that at least one of x and y is not 0.

Dawson structure: HₓA_{y}[B₂D₁₈O₆₂].zH₂O Formula (C)

In the formula (C), x, y and z are values falling within the ranges of (0≦x≦8), (0≦y≦8) and (0≦z≦50), respectively, provided that at least one of x and y is not 0.

Preyssler structure: HₓA_{y}[B₅D₃₀O₁₁₀].zH₂O Formula (D)

In the formula (D), x, y and z are values falling within the ranges of (0≦x≦15), (0≦y≦15) and (0≦z≦50), respectively, provided that at least one of x and y is not 0.

Incidentally, in the foregoing formulae (A) to (D), A represents lithium (Li), sodium (Na), potassium (K), rubidium (Rb), cesium (Cs), magnesium (Mg), calcium (Ca), aluminum (Al), ammonium (NH₄), an ammonium salt or a phosphonium salt; B represents phosphorus (P), silicon (Si), arsenic (As) or germanium (Ge); and D is at least one element selected from the group consisting of titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re) and thallium (Tl).

More specifically, for example, a compound represented by the following formula (1) is exemplified as the heteropolyacid and/or the heteropolyacid compound. This compound represented by the formula (1) is a heteropolyacid and/or a heteropolyacid compound in which a heteropolyacid ion thereof takes a Keggin structure and is preferable because it is easily soluble in the electrolytic solution.

Ax[BD12O40].yH2O Formula (I)

In the formula (1), A represents Li, Na, K, Rb, Cs, Mg, Ca, Al, NH₄, a quaternary ammonium salt or a phosphonium salt; B represents P, Si, As or Ge; D represents at least one element selected from the group consisting of Ti, V, Cr, Mn, Fe, Co, Ni, Cu, Zn, Ga, Zr, Nb, Mo, Tc, Rh, Cd, In, Sn, Ta, W, Re and Tl; and x and y are values falling within the ranges of (0≦x≦7) and (0≦y≦50), respectively.

Examples of the heteropolyacid include heteropolytungstic acids such as phosphotungstic acid and silicotungstic acid; and heteropolymolybdic acids such as phosphomolybdic acid and silicomolybdic acid. Examples of the heteropolyacid compound include heteropolytungstic acid compounds such as sodium silicotungstate, sodium phosphotungstate and ammonium phosphotungstate. Also, examples of the heteropolyacid compound include heteropolymolybdic acid compounds such as sodium phosphomolybdate and ammonium phosphomolybdate.

Also, examples of the heteropolyacid and/or the heteropolyacid compound containing plural kinds of polyelements include phosphovanadomolybdic acid, phosphotungstomolybdic acid, silicovanadomolybdic acid and silicotungstomolybdic acid.

It is preferable that the heteropolyacid compound has a cation, for example, Li⁺, Na⁺, K⁺, Rb⁺, Cs⁺, R₄N⁺, R₄P⁺, etc., wherein R is H or a hydrocarbon group having not more than 10 carbon atoms. Also, the cation is more preferably Li⁺, tetra-n-butylammonium or tetra-n-butylphosphonium. Examples of such a heteropolyacid compound include heteropolytungstic acid compounds such as sodium silicotungstate, sodium phosphotungstate, ammonium phosphotungstate and a silicotungstic acid tetra-tetra-n-butylphosphonium salt. Also, examples of the heteropolyacid compound include heteropolymolybdic acid compounds such as sodium phosphomolybdate, ammonium phosphomolybdate and a phosphomolybdic acid tri-tetra-n-butylammonium salt.

Such a heteropolyacid and/or heteropolyacid compound may be used in admixture of two or more kinds thereof. Such a heteropolyacid or heteropolyacid compound is easily soluble in the solvent, is stable in the battery and is hard to give adverse influences such as a reaction with other material.

A content of the heteropolyacid and/or the heteropolyacid compound is, for example, 0.01% by mass or more and not more than 3% by mass relative to the electrolytic solution. The content of the heteropolyacid and/or the heteropolyacid compound is preferably 0.05% by mass or more and not more than 1% by mass relative to the electrolytic solution. When the content of the heteropolyacid and/or the heteropolyacid compound is smaller than the forgoing range, as compared with the case where the content of the heteropolyacid and/or the heteropolyacid compound falls within the foregoing range, the formation of SEI is insufficient so that it becomes insufficient to protect the electrode. Also, when the content of the heteropolyacid and/or the heteropolyacid compound is larger than the foregoing range, an irreversible capacity by the reaction becomes large, so that the battery capacity tends to be lowered. Incidentally, the mass of the heteropolyacid is defined to be a value obtained by subtracting the mass of bound water which the heteropolyacid has. The mass of the heteropolyacid compound is defined to be a value obtained by subtracting the mass of bound water which the heteropolyacid compound has.

A polyoxometalate and/or a polyacid compound exhibiting solubility in the electrolytic solution may be used in place of the heteropolyacid and/or the heteropolyacid compound or together with the heteropolyacid and/or the heteropolyacid compound. Examples of such a polyoxometalate and/or polyacid compound include tungstic(VI) acid and molybdic(VI) acid. Also, there are exemplified tungstic anhydride and molybdic anhydride and hydrates thereof. Examples of the hydrate which can be used include orthotungstic acid (H₂WO₄) which is tungstic acid monohydrate (WO₃.H₂O), molybdic acid dihydrate (H₄MoO₅, H₂MoO₄.H₂O or MoO₃.2H₂O) and orthomolybdic acid (H₂MoO₄) which is molybdic acid monohydrate (MoO₃.H₂O). Also, tungstic anhydride (WO₃) having a smaller hydrogen content than metatungstic acid, paratungstic acid and the like which are an isopolyacid of the foregoing hydrate, and ultimately having a zero hydrogen content; molybdic anhydride (MoO₃) having a smaller hydrogen content than metamolybdic acid, paramolybdic acid and the like, and ultimately having a zero hydrogen content; and the like can be used.

Aromatic Compound Represented by the Formula (1)

The electrolytic solution contains the aromatic compound represented by the formula (1) together with the heteropolyacid and/or the heteropolyacid compound.

The aromatic compound represented by the formula (1) is preferably an aromatic compound represented by the following formula (2) or an aromatic compound represented by the following formula (3).

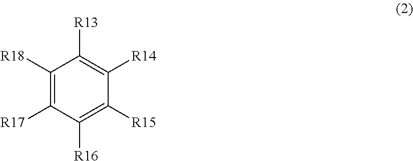

In the formula (2), R13 represents an aliphatic alkyl group, an alicyclic alkyl group or a phenyl group;

a part or all of hydrogens of R13 may be substituted with a halogen; and

each of R14 to R17 independently represents a hydrogen group or a halogen group.

In the formula (2), R13 is preferably an aliphatic alkyl group or an alicyclic group in which carbon directly bonded to the aromatic group is tertiary or quaternary, and more preferably an aliphatic alkyl group in which carbon directly bonded to the aromatic group is quaternary. Examples of the aliphatic alkyl group or alicyclic group in which carbon directly bonded to the aromatic group is tertiary or quaternary include a cyclohexyl group, a tert-butyl group, a tert-butyl group and a tert-pentyl group. In R14 to R17, the halogen group is preferably a chlorine group or a fluorine group. This is because not only such a compound is easily available, but high resistance to oxidation is obtainable.

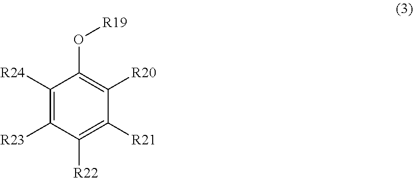

In the formula (3), R19 represents an aliphatic alkyl group, an alicyclic alkyl group or a phenyl group;

a part or all of hydrogens of R19 may be substituted with a halogen; and

each of R20 to R24 independently represents a hydrogen group or a halogen group.

In the formula (3), the aliphatic alkyl group is preferably a methyl group, an ethyl group, a tert-butyl group or a tert-pentyl group. The alicyclic group is preferably a cyclohexyl group. The halogen group is preferably a chlorine group or a fluorine group. This is because not only such a compound is easily available, but high resistance to oxidation is obtainable.

The aromatic compound represented by the formula (1) is more preferably an aromatic compound represented by the following formula (4).

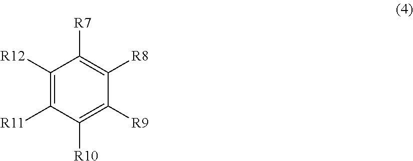

In the formula (4), R7 represents a tertiary alkyl group, a quaternary alkyl group, a phenyl group or an alkoxy group;

a part or all of hydrogens of R7 may be substituted with a halogen; and

each of R8 to R12 independently represents a hydrogen group or a halogen group.

In the formula (4), R7 is more preferably a quaternary alkyl group because the compound is hardly subjected to an oxidation-reduction reaction.

Specific examples of the aromatic compound represented by the formula (1) include the following aromatic compounds.

(a) Benzene derivatives such as chlorobenzene and fluorobenzene

(b) Biphenyl derivatives such as biphenyl, 4-fluorobiphenyl, 2-fluorobiphenyl, 3,3′-difluorobiphenyl, 4,4′-difluorobiphenyl and 4-tert-butylbiphenyl

(c) Cycloalkylbenzene derivatives such as cyclohexylbenzene

(d) Dibenzofuran or derivatives thereof.

(e) Terphenyl or compounds obtained by hydrogenating a part of terphenyl, such as 3-cyclohexylbiphenyl, 1,3-diphenylcyclohexane, 3-phenylbicyclohexyl and 1,3-dicyclohexylbenzene

(f) Diphenyl ether or derivatives thereof.

(g) Xylene derivatives such as 2-chloro-p-xylene, 4-chloro-o-xylene and 2-fluoro-p-xylene

(h) Anisole or anisole derivatives such as 4-chloroanisole, 2,4-difluoroanisole, 3,5-difluoroanisole, 4-fluoroanisole, 2-chloroanisole, 3-chloroanisole and 3-fluoroanisole

(i) Alkoxybenzene derivatives such as dimethoxybenzene, 1,4-dimethoxy-2-fluorobenzene, 1,3-dimethoxy-5-chlorobenzene and 3,5-dimethoxy-1-fluorobenzene

(j) Phenylalkane derivatives such as diphenylmethane, 1,2-diphenylethane and 2,2-diphenylpropane

(k) Aromatic compounds such as alkylbenzenes including tert-pentylbenzene, isopentylbenzene, tert-butylbenzene and isobutylbenzene

A content of the aromatic compound represented by the formula (1) is, for example, 0.1% by mass or more and not more than 5% by mass relative to the electrolytic solution. The content of the aromatic compound represented by the formula (1) is preferably 0.5% by mass or more and not more than 2% by mass relative to the electrolytic solution. When the content of the aromatic compound represented by the formula (1) is smaller than the foregoing range, the effect against the active material surface area on the positive/negative electrode is not sufficient, and as compared with the case where the content of the aromatic compound represented by the formula (1) falls within the foregoing range, the effect for suppressing the side reaction is not sufficient. When the content of the aromatic compound represented by the formula (1) is larger than the foregoing range, there is a tendency that the conductivity of the electrolytic solution is lowered.

Also, when this electrolytic solution is used for electrochemical devices, the heteropolyacid and/or the heteropolyacid compound may be added to the electrolytic solution by adding the heteropolyacid and/or the heteropolyacid compound to other battery constituent element than the electrolytic solution.

For example, in the case of adding the heteropolyacid and/or the heteropolyacid compound to a positive electrode, when the electrolytic solution is impregnated in the positive electrode, the heteropolyacid and/or the heteropolyacid compound added to the positive electrode elutes into the electrolytic solution. According to this, the heteropolyacid and/or the heteropolyacid compound can be added to the electrolytic solution.

Also, for example, in the case of adding the heteropolyacid and/or the heteropolyacid compound to a negative electrode, when the electrolytic solution is impregnated in the negative electrode, the heteropolyacid and/or the heteropolyacid compound added to the negative electrode elutes into the electrolytic solution. According to this, the heteropolyacid and/or the heteropolyacid compound can be added to the electrolytic solution.

Also, for example, in the case of adding the heteropolyacid and/or the heteropolyacid compound to a separator, when the electrolytic solution is impregnated in the separator, the heteropolyacid and/or the heteropolyacid compound added to the separator elutes into the electrolytic solution. According to this, the heteropolyacid and/or the heteropolyacid compound can be added to the electrolytic solution.

Effect

According to the first embodiment, the heteropolyacid and/or the heteropolyacid compound is contained together with the aromatic compound represented by the formula (1) into the electrolytic solution. According to this, for example, when used for electrochemical devices such as batteries, the characteristics of the electrochemical devices can be improved.

### 2. Second Embodiment

Configuration of Nonaqueous Electrolyte Battery

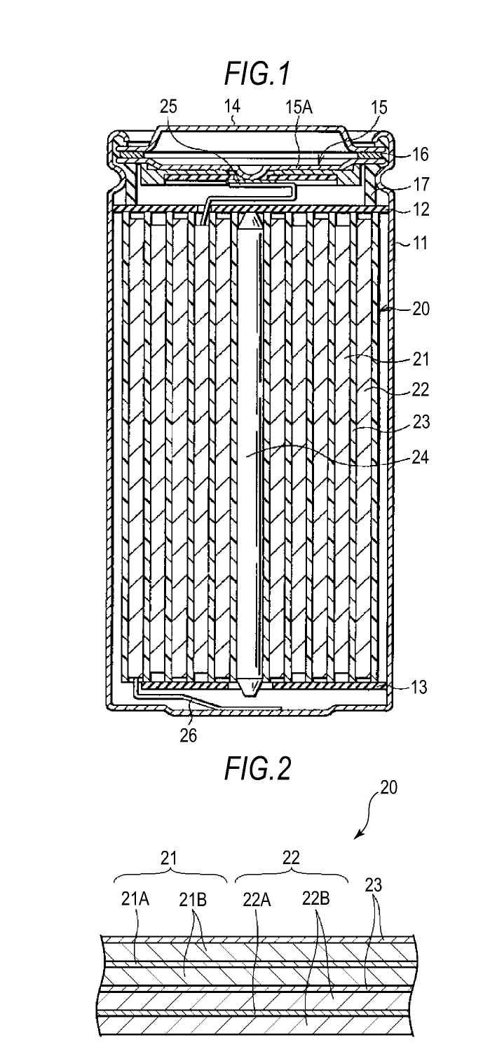

A nonaqueous electrolyte battery according to a second embodiment is described. FIG. 1 shows a sectional configuration of the nonaqueous electrolyte battery according to the second embodiment. FIG. 2 shows enlargedly a part of a wound electrode body 20 shown in FIG. 1. This nonaqueous electrolyte battery is, for example, a lithium ion secondary battery in which a capacity of a negative electrode is expressed on the basis of intercalation and deintercalation of lithium that is an electrode reactant.

In this nonaqueous electrolyte battery, a wound electrode body 20 in which a positive electrode 21 and a negative electrode 22 are laminated via a separator 23 and wound and a pair of insulating plates 12 and 13 are housed mainly in the inside of a substantially hollow columnar battery can 11. A battery structure using this columnar battery can 11 is called a cylindrical type.

The battery can 11 is constituted of, for example, iron (Fe) plated with nickel (Ni), and one end thereof is closed, with the other end being opened. In the inside of the battery can 11, a pair of the insulating plates 12 and 13 is respectively disposed vertical to the winding peripheral face so as to interpose the wound electrode body 20 therebetween.

In the open end of the battery can 11, a battery lid 14 is installed by caulking with a safety valve mechanism 15 and a positive temperature coefficient device (PTC device) 16 provided in the inside of this battery lid 14 via a gasket 17, and the inside of the battery can 11 is hermetically sealed.

The battery lid 14 is, for example, constituted of the same material as that in the battery can 11. The safety valve mechanism 15 is electrically connected to the battery lid 14 via the positive temperature coefficient device 16. In this safety valve mechanism 15, when the internal pressure of the battery reaches a fixed value or more due to an internal short circuit or heating from the outside or the like, a disc plate 15A is reversed, whereby electrical connection between the battery lid 14 and the wound electrode body 20 is disconnected.

When the temperature rises, the positive temperature coefficient device 16 controls the current by an increase of the resistance value, thereby preventing abnormal heat generation to be caused due to a large current. The gasket 17 is, for example, constituted of an insulating material, and asphalt is coated on the surface thereof.

For example, a center pin 24 is inserted in the center of the wound electrode body 20. In the wound electrode body 20, a positive electrode lead 25 made of aluminum (Al) or the like is connected to the positive electrode 21; and a negative electrode lead 26 made of nickel (Ni) or the like is connected to the negative electrode 22. The positive electrode lead 25 is electrically connected to the battery lid 14 by means of welding to the safety valve mechanism 15; and the negative electrode lead 26 is electrically connected to the battery can 11 by means of welding.

Positive Electrode

The positive electrode 21 is, for example, one in which a positive electrode active material layer 21B is provided on the both surfaces of a positive electrode collector 21A having a pair of surfaces opposing to each other. However, the positive electrode active material layer 21B may be provided on only one surface of the positive electrode collector 21A.

The positive electrode collector 21A is, for example, constituted of a metal material such as aluminum, nickel and stainless steel.

The positive electrode active material layer 21B contains, as a positive electrode active material, one or two or more kinds of a positive electrode material capable of intercalating and deintercalating lithium and may further contain other material such as a binder and a conductive agent, if desired.

Positive Electrode Material

As the positive electrode material capable of intercalating and deintercalating lithium, for example, a lithium-containing compound is preferable. This is because a high energy density is obtainable. Examples of this lithium-containing compound include a complex oxide containing lithium and a transition metal element and a phosphate compound containing lithium and a transition metal element. Of these, a compound containing at least one member selected from the group consisting of cobalt, nickel, manganese and iron as the transition metal element is preferable. This is because a higher voltage is obtainable.

Examples of the complex oxide containing lithium and a transition metal element include a lithium cobalt complex oxide (LiₓCoO₂), a lithium nickel complex oxide (LiₓNiO₂), a lithium nickel cobalt complex oxide (LiₓNi_{1-z}CO_{z}O₂ (z<1)), a lithium nickel cobalt manganese complex oxide (LiₓNi_{(1-v-w)}CoᵥMn_{w}O₂ ((v+w)<1)), and a lithium manganese complex oxide (LiMn₂O₄) or a lithium manganese nickel complex oxide (LiMn₂₋ₜNiₜO₄ (t<2)) each having a spinel type structure. Of these, cobalt-containing complex oxides are preferable. This is because not only a high capacity is obtainable, but an excellent cycle characteristic is obtainable. Also, examples of the phosphate compound containing lithium and a transition metal element include a lithium iron phosphate compound (LiFePO₄), a lithium iron manganese phosphate compound (LiFe₁₋ᵤMnᵤPO₄ (u<1)) and LiₓFe_{1-y}M2_{y}PO₄ (wherein M2 represents at least one member selected from the group consisting of manganese (Mn), nickel (Ni), cobalt (Co), zinc (Zn) and magnesium (Mg); and x is a value falling with the range of (0.9≦x≦1.1)).

Moreover, from the viewpoint that higher electrode filling properties and cycle characteristic are obtainable, the positive electrode material capable of intercalating and deintercalating lithium may be formed as a complex particle obtained by coating the surface of a core particle composed of any one of the foregoing lithium-containing compounds by a fine particle composed of any one of other lithium-containing compounds.

Besides, examples of the positive electrode material capable of intercalating and deintercalating lithium include oxides such as titanium oxide, vanadium oxide and manganese dioxide; disulfides such as titanium disulfide and molybdenum sulfide; chalcogenides such as niobium selenide; sulfur; and conductive polymers such as polyaniline and polythiophene. As a matter of course, the positive electrode material capable of intercalating and deintercalating lithium may be other material than those described above. Also, the above-exemplified series of positive electrode materials may be a mixture of two or more kinds thereof in an arbitrary combination.

Negative Electrode

The negative electrode 22 is, for example, one in which a negative electrode active material layer 22B is provided on the both surfaces of a negative electrode collector 22A having a pair of surfaces opposing to each other. However, the negative electrode active material layer 22B may be provided on only one surface of the negative electrode collector 22A.

The negative electrode collector 22A is, for example, constituted of a metal material such as copper, nickel and stainless steel.

The negative electrode active material layer 22B contains, as a negative electrode active material, one or two or more kinds of a negative electrode material capable of intercalating and deintercalating lithium and may further contain other material such as a binder and a conductive agent, if desired. On that occasion, it is preferable that a rechargeable capacity on the negative electrode material capable of intercalating and deintercalating lithium is larger than a discharge capacity of the positive electrode. Details regarding the binder and the conductive agent are the same as those in the positive electrode.

Examples of the negative electrode material capable of intercalating and deintercalating lithium include carbon materials. Examples of such a carbon material include easily graphitized carbon, hardly graphitized carbon with a (002) plane interval of 0.37 nm or more and graphite with a (002) plane interval of not more than 0.34 nm. More specifically, there are exemplified pyrolytic carbons, cokes, vitreous carbon fibers, organic polymer compound baked materials, active carbon and carbon blacks. Of these, examples of the cokes include pitch coke, needle coke and petroleum coke. The organic polymer compound baked material as referred to herein is a material obtained through carbonization by baking a phenol resin, a furan resin or the like at an appropriate temperature. The carbon material is preferable because a change in a crystal structure following the intercalation and deintercalation of lithium is very small, and therefore, a high energy density is obtainable, an excellent cycle characteristic is obtainable, and the carbon material also functions as a conductive agent. Incidentally, the shape of the carbon material may be any of a fibrous shape, a spherical shape, a granular shape or a flaky shape.

In addition to the foregoing carbon materials, examples of the negative electrode material capable of intercalating and deintercalating lithium include a material capable of intercalating and deintercalating lithium and containing, as a constituent element, at least one member selected from the group consisting of metal elements and semi-metal elements. This is because a high energy density is obtainable. Such a negative electrode material may be a simple substance, an alloy or a compound of a metal element or a semi-metal element, or may be one having one or two or more kinds of a phase in at least a part thereof. The “alloy” as referred to herein includes, in addition to alloys composed of two or more kinds of a metal element, alloys containing one or more kinds of a metal element and one or more kinds of a semi-metal element. Also, the “alloy” may contain a non-metal element. Examples of its texture include a solid solution, a eutectic (eutectic mixture), an intermetallic compound and one in which two or more kinds thereof coexist.

Examples of the metal element or semi-metal element include a metal element or a semi-metal element capable of forming an alloy together with lithium. Specific examples thereof include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt). Of these, at least one member selected from silicon and tin is preferable, and silicon is more preferable. This is because silicon and tin have large capability to intercalate and deintercalate lithium, so that a high energy density is obtainable.

Examples of the negative electrode material containing at least one member selected from silicon and tin include a simple substance, an alloy or a compound of silicon; a simple substance, an alloy or a compound of tin; and one having one or two or more kinds of a phase in at least a part thereof.

Examples of alloys of silicon include alloys containing, as a second constituent element other than silicon, at least one member selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of alloys of tin include alloys containing, as a second constituent element other than tin (Sn), at least one member selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr).

Examples of compounds of tin or compounds of silicon include compounds containing oxygen (O) or carbon (C), and these compounds may further contain the foregoing second constituent element in addition to tin (Sn) or silicon (Si).

As the negative electrode material containing at least one member selected from silicon (Si) and tin (Sn), for example, a material containing tin (Sn) as a first constituent element and in addition to this tin (Sn), a second constituent element and a third constituent element is especially preferable. As a matter of course, this negative electrode material may be used together with the foregoing negative electrode material. The second constituent element is at least one member selected from the group consisting of cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi) and silicon (Si). The third constituent element is at least one member selected from the group consisting of boron (B), carbon (C), aluminum (Al) and phosphorus (P). This is because when the second constituent element and the third constituent element are contained, a cycle characteristic is enhanced.

Above of all, the negative electrode material is preferably an SnCoC-containing material containing tin (Sn), cobalt (Co) and carbon (C) as constituent elements and having a content of carbon (C) in the range of 9.9% by mass or more and not more than 29.7% by mass and a proportion of cobalt (Co) to the total sum of tin (Sn) and cobalt (Co)(Co/(Sn+Co)) in the range of 30% by mass or more and not more than 70% by mass. This is because in the foregoing composition range, not only a high energy density is obtainable, but an excellent cycle characteristic is obtainable.

This SnCoC-containing material may further contain other constituent element, if desired. As other constituent element, for example, silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga) and bismuth (Bi) are preferable. The SnCoC-containing material may contain two or more kinds of these elements. This is because a capacity characteristic or a cycle characteristic is more enhanced.

Incidentally, the SnCoC-containing material has a phase containing tin (Sn), cobalt (Co) and carbon (C), and it is preferable that this phase has a lowly crystalline or amorphous structure. Also, in the SnCoC-containing material, it is preferable that at least a part of carbons that are a constituent element is bound to a metal element or a semi-metal element that is other constituent element. This is because though it may be considered that a lowering of the cycle characteristic is caused due to aggregation or crystallization of tin (Sn) or the like, when carbon is bound to other element, such aggregation or crystallization is suppressed.

Examples of a measurement method for examining the binding state of elements include X-ray photoelectron spectroscopy (XPS). In this XPS, so far as graphite is concerned, a peak of the 1s orbit (C1s) of carbon appears at 284.5 eV in an energy-calibrated apparatus such that a peak of the 4f orbit of a gold atom (Au4f) is obtained at 84.0 eV. Also, so far as surface contamination carbon is concerned, a peak of the is orbit (C1s) of carbon appears at 284.8 eV. On the contrary, when a charge density of the carbon element is high, for example, when carbon is bound to a metal element or a semi-metal element, the peak of C1s appears in a lower region than 284.5 eV. That is, when a peak of a combined wave of C1s obtained regarding the SnCoC-containing material appears in a lower region than 284.5 eV, at least a part of carbons (C) contained in the SnCoC-containing material is bound to a metal element or a semi-metal element as other constituent element.

Incidentally, in the XPS measurement, for example, the peak of C1s is used for correcting the energy axis of a spectrum. In general, since surface contamination carbon exists on the surface, the peak of C1s of the surface contamination carbon is fixed at 284.8 eV, and this peak is used as an energy reference. In the XPS measurement, since a waveform of the peak of C1s is obtained as a form including the peak of the surface contamination carbon and the peak of carbon in the SnCoC-containing material, the peak of the surface contamination carbon and the peak of the carbon in the SnCoC-containing material are separated from each other by means of analysis using, for example, a commercially available software program. In the analysis of the waveform, the position of a main peak existing on the lowest binding energy side is used as an energy reference (284.8 eV).

Also, examples of the negative electrode material capable of intercalating and deintercalating lithium include metal oxides and polymer compounds, each of which is capable of intercalating and deintercalating lithium. Examples of the metal oxide include iron oxide, ruthenium oxide and molybdenum oxide; and examples of the polymer compound include polyacetylene, polyaniline and polypyrrole.

Incidentally, the negative electrode material capable of intercalating and deintercalating lithium may be other material than those described above. Also, the above-exemplified negative electrode materials may be a mixture of two or more kinds thereof in an arbitrary combination.

The negative electrode active material layer 22B may be, for example, formed by any of a vapor phase method, a liquid phase method, a spraying method, a baking method or a coating method, or a combined method of two or more kinds of these methods. When the negative electrode active material layer 22B is formed by adopting a vapor phase method, a liquid phase method, a spraying method, a baking method or a combined method of two or more kinds of these methods, it is preferable that the negative electrode active material layer 22B and the negative electrode collector 22A are alloyed on at least a part of an interface therebetween. Specifically, it is preferable that on the interface, the constituent elements of the negative electrode collector 22A are diffused into the negative electrode active material layer 22B, the constituent elements of the negative electrode active material layer 22B are diffused into the negative electrode collector 22A, or these constituent elements are mutually diffused into each other. This is because not only breakage to be caused due to expansion and shrinkage of the negative electrode active material layer 22B following the charge/discharge can be suppressed, but electron conductivity between the negative electrode active material layer 22B and the negative electrode collector 22A can be enhanced.

Incidentally, examples of the vapor phase method include a physical deposition method and a chemical deposition method, specifically a vacuum vapor deposition method, a sputtering method, an ion plating method, a laser abrasion method, a thermal chemical vapor deposition (CVD) method and a plasma chemical vapor deposition method. As the liquid phase method, known techniques such as electrolytic plating and electroless plating can be adopted. The baking method as referred to herein is, for example, a method in which after a granular negative electrode active material is mixed with a binder and the like, the mixture is dispersed in a solvent and coated, and the coated material is then heat treated at a higher temperature than a melting point of the binder or the like. As to the baking method, known techniques can be utilized, too, and examples thereof include an atmospheric baking method, a reaction baking method and a hot press baking method.

Separator

The separator 23 partitions the positive electrode 21 and the negative electrode 22 from each other and allows a lithium ion to pass therethrough while preventing a short circuit of the current to be caused due to the contact between the both electrodes. This separator 23 is constituted of, for example, a porous film made of a synthetic resin such as polytetrafluoroethylene, polypropylene and polyethylene; a porous film made of a ceramic; or the like, and a laminate of two or more kinds of these porous films may also be used. The separator 23 may be impregnated with the electrolytic solution according to the foregoing first embodiment.

Manufacturing Method of Nonaqueous Electrolyte Battery

The foregoing nonaqueous electrolyte battery can be manufactured in the following manner.

Manufacture of Positive Electrode

First of all, the positive electrode 21 is fabricated. For example, a positive electrode material, a binder and a conductive agent are mixed to form a positive electrode mixture, which is then dispersed in an organic solvent to form a positive electrode mixture slurry in a paste form. Subsequently, the positive electrode mixture slurry is uniformly coated on the both surfaces of the positive electrode collector 21A by a doctor blade or a bar coater or the like and then dried. Finally, the coating is subjected to compression molding by a roll press or the like while heating, if desired, thereby forming the positive electrode active material layer 21B. In that case, the compression molding may be repeatedly carried out plural times.

Manufacture of Negative Electrode

Next, the negative electrode 22 is fabricated. For example, a negative electrode material and a binder and optionally, a conductive agent are mixed to form a negative electrode mixture, which is then dispersed in an organic solvent to form a negative electrode mixture slurry in a paste form. Subsequently, the negative electrode mixture slurry is uniformly coated on the both surfaces of the negative electrode collector 22A by a doctor blade or a bar coater or the like and then dried. Finally, the coating is subjected to compression molding by a roll press or the like while heating, if desired, thereby forming the negative electrode active material layer 22B.

Next, the positive electrode lead 25 is installed in the positive electrode collector 21A by means of welding or the like, and the negative electrode lead 26 is also installed in the negative electrode collector 22A by means of welding or the like. Thereafter, the positive electrode 21 and the negative electrode 22 are wound via the separator 23; a tip end of the positive electrode lead 25 is welded to the safety valve mechanism 15; and a tip end of the negative electrode lead 26 is also welded to the battery can 11. Then, the wound positive electrode 21 and negative electrode 22 are interposed between a pair of the insulating plates 12 and 13 and housed in the inside of the battery can 11. After housing the positive electrode 21 and the negative electrode 22 in the inside of the battery can 11, the electrolytic solution according to the first embodiment is injected into the inside of the battery can 21 and impregnated in the separator 23. Thereafter, the battery lid 14, the safety valve mechanism 15 and the positive temperature coefficient device 16 are fixed to the open end of the battery can 11 upon being caulked via the gasket 17. There is thus completed the nonaqueous electrolyte battery shown in FIGS. 1 and 2.

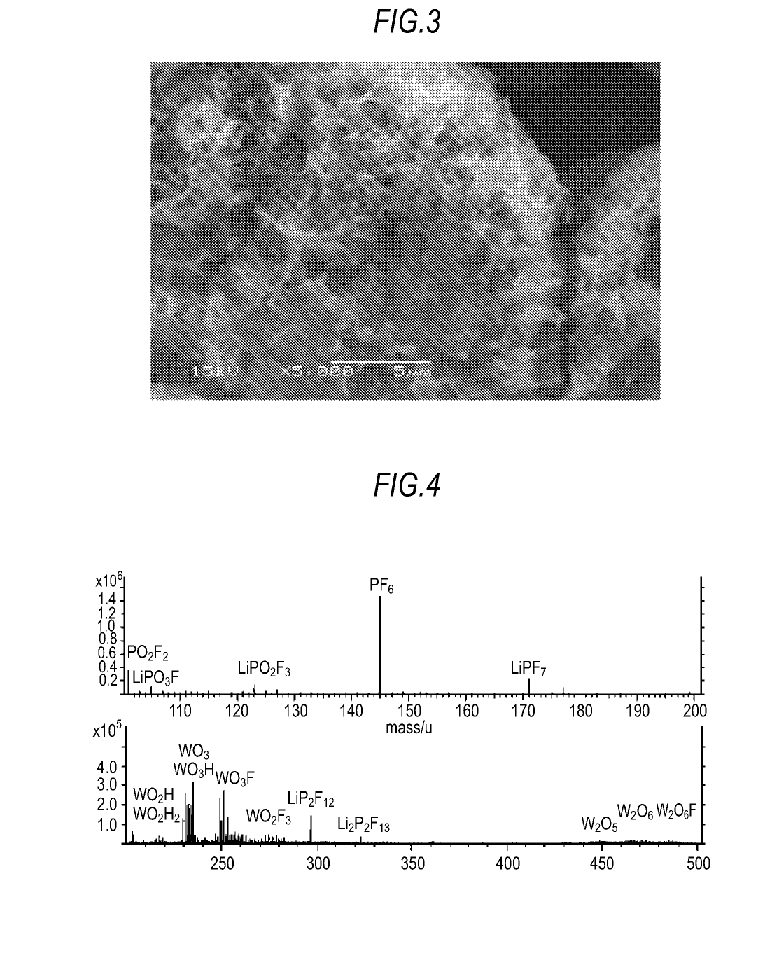

In the nonaqueous electrolyte battery according to the second embodiment, an electrolytic solution containing the aromatic compound represented by the formula (1) and the heteropolyacid and/or the heteropolyacid compound is used. The aromatic compound represented by the formula (1) adsorbs on the electrode surface and lowers the reaction with the electrolytic solution. The heteropolyacid and/or the heteropolyacid compound is a compound capable of intercalating and deintercalating a lithium ion and takes a relatively stable structure. The heteropolyacid and/or the heteropolyacid compound is electrolyzed at the time of charge/discharge at the initial stage of use, and a compound derived from the heteropolyacid and/or the heteropolyacid compound is deposited on the surface of the negative electrode, thereby forming a stable coating which is called an SEI (solid electrolyte interface coating) on the negative electrode. According to this, the decomposition of the solvent, the electrolyte salt and the aromatic compound represented by the formula (1) in the electrolytic solution is suppressed. As shown in FIG. 3, this coating can be, for example, confirmed by SEM (scanning electron microscope). Incidentally, FIG. 3 is an SEM image of the negative electrode surface after charge and is a photograph taken after washing the nonaqueous electrolytic solution and then drying. This coating is inorganic and stiff and at the same time, is low in resistance at the time of intercalating and deintercalating a lithium ion, and therefore, it may be considered that this coating hardly causes deterioration of the capacity, or the like. In view of the fact that a decomposition reaction of the aromatic compound represented by the formula (1) on the negative electrode is suppressed by this coating, properties of suppressing the side reaction on the positive electrode, which the aromatic compound represented by the formula (1) has, can be sufficiently revealed on the positive electrode, whereby excellent battery characteristics can be obtained due to a synergistic effect.

Also, the heteropolyacid and/or the heteropolyacid compound in the electrolytic solution is electrolyzed by initial charge or preliminary charge depending upon the addition amount, whereby a compound derived from the heteropolyacid and/or the heteropolyacid compound is deposited on the surface of the positive electrode 21 to form a coating.

Also, in view of the fact that the electrolytic solution having the heteropolyacid and/or the heteropolyacid compound dissolved therein is impregnated in the negative electrode active material layer 22B, a compound derived from the heteropolyacid and/or the heteropolyacid compound may be deposited within the negative electrode active material layer 22B by charge or preliminary charge. According to this, the compound derived from the heteropolyacid and/or the heteropolyacid compound may exist among the negative electrode active material particles.

Also, in view of the fact that the electrolytic solution having the heteropolyacid and/or the heteropolyacid compound dissolved therein is impregnated in the positive electrode active material layer 21B, a compound derived from the heteropolyacid and/or the heteropolyacid compound may be deposited within the positive electrode active material layer 21B by charge or preliminary charge. According to this, the compound derived from the heteropolyacid and/or the heteropolyacid compound may exist among positive electrode active material particles.

The deposited compound which is derived from the heteropolyacid and/or the heteropolyacid compound includes a cluster of oxoacid and/or a cluster of oxoacidic compound having one or more kinds of a addenda atom, or a reduced material of a cluster of oxoacid and/or a cluster of oxoacidic having one or more kinds of a addenda atom, each of which is poorer in solubility than the heteropolyacid and/or the heteropolyacid compound before the electrolysis, or the like.

Specifically, the cluster of oxoacid and/or the cluster of oxoacidic deposited on the surface of the negative electrode 22 is amorphous. For example, this amorphous cluster of oxoacid and/or cluster of oxoacidic absorbs the electrolytic solution and exists as the coating in a gel form of the negative electrode 22 on the negative electrode surface. For example, a deposit containing the cluster of oxoacid and/or the cluster of oxoacidic, which is deposited on the negative electrode 22, grows in a three-dimensional network structure and deposits at the time of preliminary charge or at the time of charge. Also, at least a part of the deposited cluster of oxoacid and/or cluster of oxoacidic may be reduced.

The presence or absence of the coating derived from the cluster of oxoacid and/or the cluster of oxoacidic can be confirmed by disassembling the nonaqueous electrolyte battery after charge or preliminary charge and taking out the electrode. For example, when a composition of the deposit deposited on the collector is confirmed, and the cluster of oxoacid and/or the cluster of oxoacidic produced by electrolysis is deposited, it can be easily supposed that the oxoacid and/or the cluster of oxoacidic is also similarly deposited on the active material layer, and it can be confirmed that the coating derived from the cluster of oxoacid and/or the cluster of oxoacidic is formed.

The presence or absence of the deposited cluster of oxoacid and/or cluster of oxoacidic can be, for example, confirmed on the basis of structural analysis by the X-ray absorption fine structure (XAFS) analysis and chemical information of a molecule by the time-of-flight secondary ion mass spectrometry (ToF-SIMS). In that case, the battery is disassembled, followed by washing with dimethyl carbonate. This is made for the purpose of removing a solvent component with low volatility and an electrolyte salt existing on the surface. It is desirable that sampling is carried out in an inert atmosphere if it is at all possible.

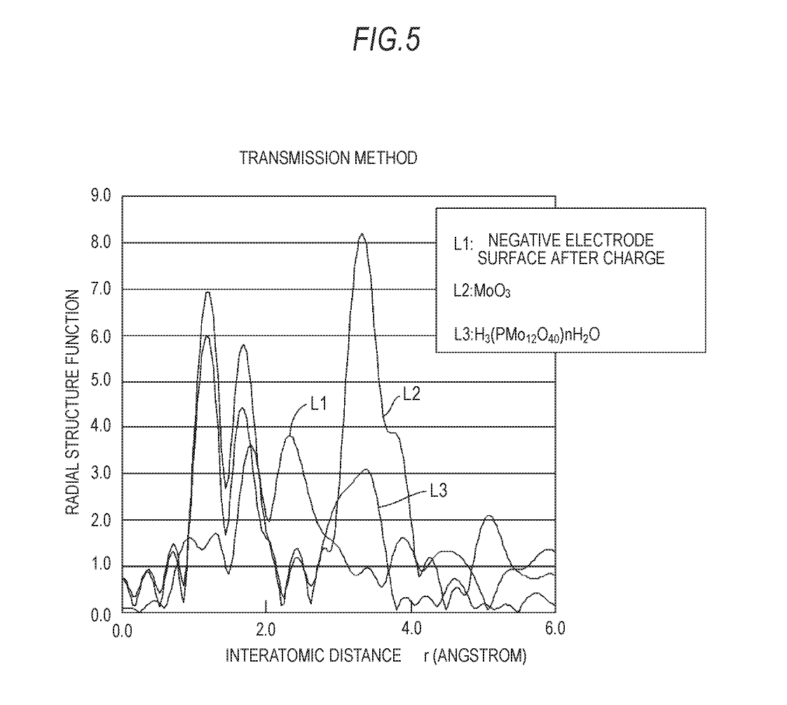

For example, FIG. 4 shows an example of a secondary ion spectrum by the time-of-flight secondary ion mass spectrometry (ToF-SIMS) on the negative electrode surface of the nonaqueous electrolyte battery in which the negative electrode coating according to the second embodiment is formed by adding silicotungstic acid into a battery system and charging the battery. It is noted from FIG. 4 that a molecule containing, as constituent elements, tungsten (W) and oxygen (O) is existent.

Also, FIG. 5 shows an example of a radial structure function of a W—O bond obtained by the Fourier transformation of a spectrum by the X-ray absorption fine structure (XAFS) analysis on the negative electrode surface of the nonaqueous electrolyte battery in which the negative electrode coating according to the second embodiment is formed by adding silicotungstic acid into a battery system and charging the battery. Also, FIG. 5 shows an example of a radial structure function of a W—O bond of each of tungstic acid (WO₃ or WO₂) and silicotungstic acid (H₄(SiW₁₂O₄₀).26H₂O) along with the analysis results of the negative electrode coating.

It is noted from FIG. 5 that a peak L1 of a deposit on the negative electrode surface has peaks at a different position from peaks L2, L3 and L4 of silicotungstic acid (H₄(SiW₁₂O₄₀).26H₂O), tungsten dioxide (WO₂) and tungsten trioxide (WO₃), respectively and has a different structure. In tungsten trioxide (WO₃) and tungsten dioxide (WO₂), both of which are a typical tungsten oxide, and silicotungstic acid (H₄(SiW₁₂O₄₀).26H₂O) which is a starting material according to the second embodiment, in view of the radical structure function, main peaks are existent in the range of from 1.0 to 2.0 angstroms, and peaks can also be confirmed in the range of from 2.0 to 4.0 angstroms.

On the other hand, in the distribution of the W—O bond distance of the polyacid composed mainly of tungstic acid deposited on each of the positive electrode and the negative electrode according to the second embodiment, though the peaks are confirmed within the range of from 1.0 to 2.0 angstroms, distinct peaks equivalent to those in the peak L1 are not found in the outside of the foregoing range. That is, no peak is substantially observed in the range exceeding 3.0 angstroms. In such a situation, it is confirmed that the deposit on the negative electrode surface is amorphous.

Effect

According to the second embodiment, the heteropolyacid and/or the heteropolyacid compound is incorporated together with the aromatic compound represented by the formula (1) into the electrolytic solution. According to this, by forming the coating derived from the heteropolyacid and/or the heteropolyacid compound on the negative electrode surface, a decomposition reaction of the aromatic compound represented by the formula (1) on the negative electrode is suppressed. According to this, the original properties of the aromatic compound represented by the formula (1) are sufficiently revealed on the positive electrode, whereby excellent battery characteristics can be obtained due to a synergistic effect.

### 3. Third Embodiment

Configuration of Nonaqueous Electrolyte Battery

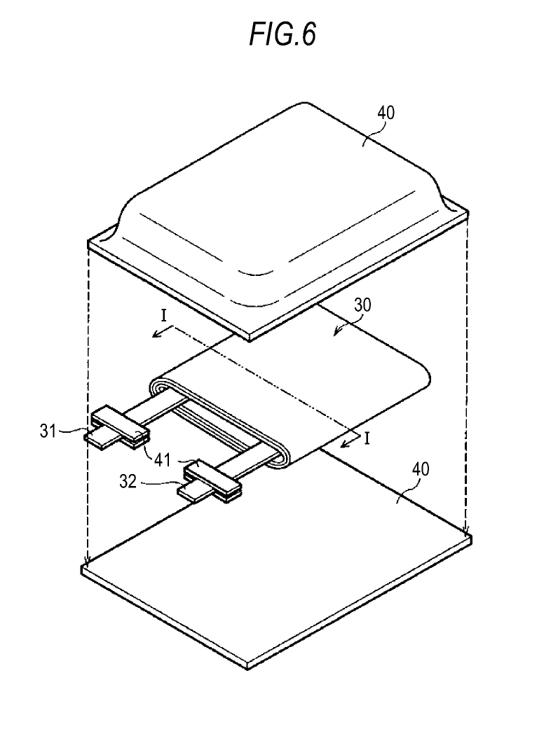

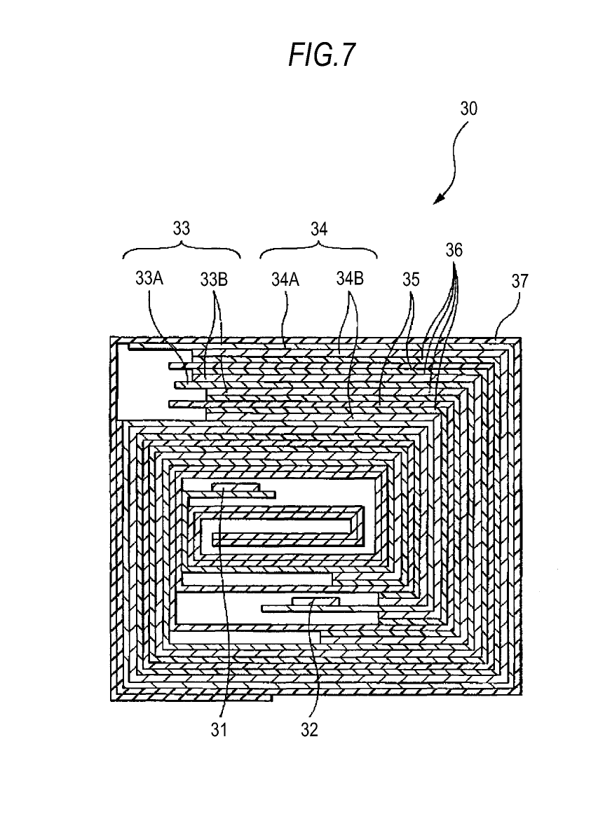

The nonaqueous electrolyte battery according to the third embodiment is described. FIG. 6 is an exploded perspective configuration of the nonaqueous electrolyte battery according to the third embodiment; and FIG. 7 shows enlargedly a section along an I-I line of a wound electrode body 30 shown in FIG. 6.

This nonaqueous electrolyte battery has a configuration in which the wound electrode body 30 having mainly a positive electrode lead 31 and a negative electrode lead 32 installed therein is housed in the inside of a film-shaped package member 40. A battery structure using this film-shaped package member 40 is called a laminated film type.

Each of the positive electrode lead 31 and the negative electrode lead 32 is, for example, led out from the inside of the package member 40 toward the outside in the same direction. The positive electrode lead 31 is, for example, constituted of a metal material such as aluminum, and the negative electrode lead 32 is, for example, constituted of a metal material such as copper, nickel and stainless steel. Such a metal material is, for example, formed in a thin plate state or a network state.

The package member 40 is, for example, constituted of an aluminum laminated film obtained by sticking a nylon film, an aluminum foil and a polyethylene film in this order. For example, this package member 40 has a structure in which respective outer edges of the two rectangular aluminum laminated films are allowed to adhere to each other by means of fusion or with an adhesive in such a manner that the polyethylene film is disposed opposing to the wound electrode body 30.

A contact film 41 is inserted between the package member 40 and each of the positive electrode lead 31 and the negative electrode lead 32 for the purpose of preventing invasion of the outside air from occurring. This contact film 41 is constituted of a material having adhesion to each of the positive electrode lead 31 and the negative electrode lead 32. Examples of such a material include polyolefin resins such as polyethylene, polypropylene, modified polyethylene and modified polypropylene.

Incidentally, the package member 40 may also be constituted of a laminated film having other lamination structure, or constituted of a polymer film such as polypropylene or a metal film, in place of the foregoing aluminum laminated film.

FIG. 7 shows a sectional configuration along an I-I line of the wound electrode body 30 shown in FIG. 6. This wound electrode body 30 is one prepared by laminating a positive electrode 33 and a negative electrode 34 via a separator 35 and an electrolyte 36 and winding the laminate, and an outermost peripheral part thereof is protected by a protective tape 37.

The positive electrode 33 is, for example, one in which a positive electrode active material layer 33B is provided on the both surfaces of a positive electrode collector 33A. The negative electrode 34 is, for example, one in which a negative electrode active material layer 34B is provided on the both surfaces of a negative electrode collector 34A, and the negative electrode active material layer 34B is disposed opposing to the positive electrode active material layer 33B. The configurations of the positive electrode collector 33A, the positive electrode active material layer 33B, the negative electrode collector 34A, the negative electrode active material layer 34B and the separator 35 are the same as those of the positive electrode collector 21A, the positive electrode active material layer 21B, the negative electrode collector 22A, the negative electrode active material layer 22B and the separator 23, respectively according to the second embodiment.

The electrolyte 36 contains the electrolytic solution according to the first embodiment and a polymer compound capable of holding this electrolytic solution therein and is an electrolyte in a so-called gel form. The electrolyte in a gel form is preferable because not only a high ion conductivity (for example, 1 mS/cm or more at room temperature) is obtainable, but liquid leakage can be prevented from occurring.

As the polymer compound, a compound which is gelled upon absorption of the electrolytic solution can be used. Examples thereof include polyacrylonitrile, polyvinylidene fluoride, a copolymer of polyvinylidene fluoride and polyhexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, a styrene-butadiene rubber, a nitrile-butadiene rubber, polystyrene and polycarbonate. These materials may be used singly or in admixture of plural kinds thereof. Of these, polyacrylonitrile, polyvinylidene fluoride, polyhexafluoropropylene or polyethylene oxide is preferable. This is because such a compound is electrochemically stable.

Manufacturing Method of Nonaqueous Electrolyte Battery

This nonaqueous electrolyte battery is, for example, manufactured by the following three kinds of manufacturing methods (first to third manufacturing methods).

First Manufacturing Method

In a first manufacturing method, first of all, for example, the positive electrode active material layer 33B is formed on the both surfaces of the positive electrode collector 33A to fabricate the positive electrode 33, and the negative electrode active material layer 34B is formed on the both surfaces of the negative electrode collector 34A to fabricate the negative electrode 34, respectively, according to the same fabrication procedures of the positive electrode 21 and the negative electrode 22 according to the second embodiment.

Subsequently, a precursor solution containing the electrolytic solution according to the first embodiment, a polymer compound and a solvent is prepared and coated on each of the positive electrode 33 and the negative electrode 34, and the solvent is then volatilized to form the electrolyte 36 in a gel form. Subsequently, the positive electrode lead 31 is installed in the positive electrode collector 33A, and the negative electrode lead 32 is also installed in the negative electrode collector 34A.

Subsequently, the positive electrode 33 and the negative electrode 34 each having the electrolyte 36 formed thereon are laminated via the separator 35, the laminate is wound in a longitudinal direction thereof, and thereafter, the protective tape 37 is allowed to adhere to an outermost peripheral part thereof, thereby fabricating the wound electrode body 30. Finally, for example, the wound electrode body 30 is interposed between the two package members 40 in a film form, and the outer edges of the package members 40 are allowed to adhere to each other by means of heat fusion or the like, thereby enclosing the wound electrode body 30 therein. On that occasion, the contact film 41 is inserted between each of the positive electrode lead 31 and the negative electrode lead 32 and the package member 40. There is thus completed the nonaqueous electrolyte battery.

Second Manufacturing Method

In a second manufacturing method, first of all, the positive electrode lead 31 is installed in the positive electrode 33, and the negative electrode lead 32 is also installed in the negative electrode 34. Subsequently, the positive electrode 33 and the negative electrode 34 are laminated via the separator 35, the laminate is wound in a longitudinal direction thereof, and thereafter, the protective tape 37 is allowed to adhere to an outermost peripheral part thereof, thereby fabricating a wound body that is a precursor of the wound electrode body 30.

Subsequently, the wound body is interposed between the two package members 40 in a film form, and the outer edges exclusive of one side are allowed to adhere to each other by heat fusion or the like, thereby housing the wound body in the inside of the package member 40 in a bag form. Subsequently, an electrolyte composition containing the electrolytic solution according to the first embodiment, a monomer that is a raw material of a polymer compound, a polymerization initiator and optionally, other material such as a polymerization inhibitor is prepared and injected into the inside of the package member 40 in a bag form, and thereafter, an opening of the package member 40 is hermetically sealed by means of heat fusion or the like. Finally, the monomer is heat polymerized to prepare a polymer compound, thereby forming the electrolyte 36 in a gel form. There is thus completed the nonaqueous electrolyte battery.

Third Manufacturing Method

In a third manufacturing method, first of all, a wound body is formed and housed in the inside of the package member 40 in a bag form in the same manner as in the foregoing second manufacturing method, except for using the separator 35 having a polymer compound coated on the both surfaces thereof.

Examples of the polymer compound which is coated on this separator 35 include polymers composed of, as a component, vinylidene fluoride, namely a homopolymer, a copolymer or a multi-component copolymer, or the like. Specific examples thereof include polyvinylidene fluoride; a binary copolymer composed of, as components, vinylidene fluoride and hexafluoropropylene; and a ternary copolymer composed of, as components, vinylidene fluoride, hexafluoropropylene and chlorotrifluoroethylene.

Incidentally, the polymer compound may contain one or two or more kinds of other polymer compounds together with the foregoing polymer composed of, as a component, vinylidene fluoride. Subsequently, the electrolytic solution according to the first embodiment is prepared and injected in the inside of the package material 40, and thereafter, an opening of the package member 40 is hermetically sealed by means of heat fusion or the like. Finally, the separator 35 is brought into intimate contact with each of the positive electrode 33 and the negative electrode 34 via the polymer compound upon heating while adding a weight to the package member 40. According to this, the electrolytic solution is impregnated into the polymer compound, and the polymer compound is gelled to form the electrolyte 36. There is thus completed the nonaqueous electrolyte battery.

Effect

According to the third embodiment, the same effects as those according to the second embodiment are brought.

### 4. Fourth Embodiment

A nonaqueous electrolyte battery according to a fourth embodiment is described. The nonaqueous electrolyte battery according to the fourth embodiment is the same as the nonaqueous electrolyte battery according to the third embodiment, except for using the electrolytic solution according to the first embodiment as it is in place of the material (electrolyte 36) in which the electrolytic solution according to the first embodiment is held by the polymer compound. In consequence, the configuration thereof is hereunder described centering on points which are different from those according to the third embodiment.

Configuration of Nonaqueous Electrolyte Battery

In the nonaqueous electrolyte battery according to the fourth embodiment, an electrolytic solution is used in place of the electrolyte 36 in a gel form. In consequence, the wound electrode body 30 has a configuration in which the electrolyte 36 is omitted, and the electrolytic solution is impregnated in the separator 35.

Manufacturing Method of Nonaqueous Electrolyte Battery

This nonaqueous electrolyte battery is, for example, manufactured in the following manner.

First of all, for example, a positive electrode active material, a binder and a conductive agent are mixed to prepare a positive electrode mixture, and this positive electrode mixture is dispersed in a solvent such as N-methyl-2-pyrrolidone to prepare a positive electrode mixture slurry. Subsequently, this positive electrode mixture slurry is coated on the both surfaces of the positive electrode collector 33A and dried, and the resultant is then compression molded to form the positive electrode active material layer 33B. There is thus fabricated the positive electrode 33. Subsequently, for example, the positive electrode lead 31 is joined with the positive electrode collector 33A by means of, for example, ultrasonic welding, spot welding or the like.

Also, for example, a negative electrode material and a binder are mixed to prepare a negative electrode mixture, which is then dispersed in a solvent such as N-methyl-2-pyrrolidone to prepare a negative electrode mixture slurry. Subsequently, this negative electrode mixture slurry is coated on the both surfaces of the negative electrode collector 34A and dried, and the resultant is then compression molded to form the negative electrode active material layer 34B. There is thus fabricated the negative electrode 34. Subsequently, for example, the negative electrode lead 32 is joined with the negative electrode collector 34A by means of, for example, ultrasonic welding, spot welding or the like.

Subsequently, the positive electrode 33 and the negative electrode 34 are wound via the separator 35; the resultant is interposed into the package member 40; and thereafter, the electrolytic solution according to the first embodiment is injected, followed by hermetically sealing the package member 40. There is thus obtained the nonaqueous electrolyte battery shown in FIGS. 6 and 7.

Effect

According to the fourth embodiment, the same effects as those according to the second embodiment are brought.

### 5. Fifth Embodiment

Configuration of Nonaqueous Electrolyte Battery

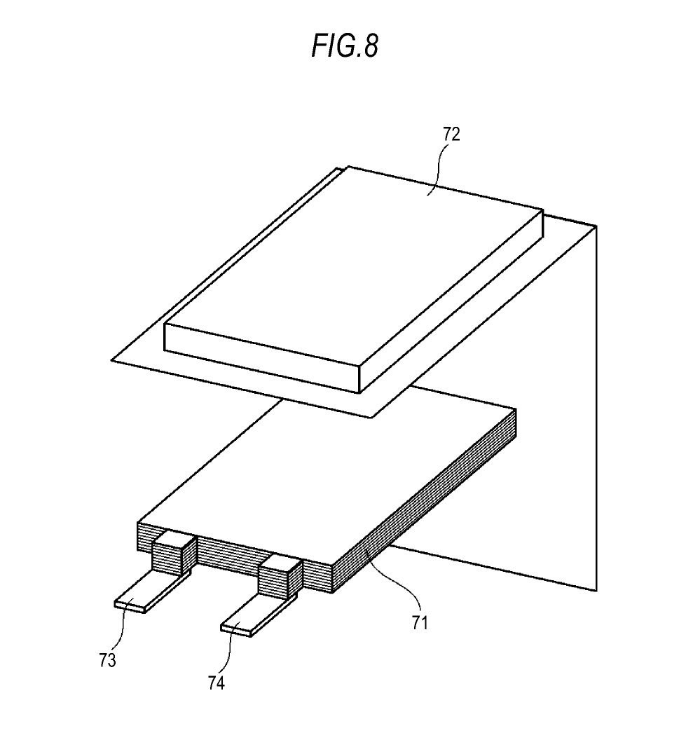

FIG. 8 is an exploded perspective view showing an example of a configuration of a nonaqueous electrolyte battery according a fifth embodiment. As shown in FIG. 8, this nonaqueous electrolyte battery is one in which a battery device 71 having a positive electrode lead 73 and a negative electrode lead 74 installed therein is housed in the inside of a package member 72 in a film form and is able to realize downsizing, weight reduction and thinning.

Each of the positive electrode lead 73 and the negative electrode lead 74 is, for example, led out from the inside of the package member 72 toward the outside in the same direction.

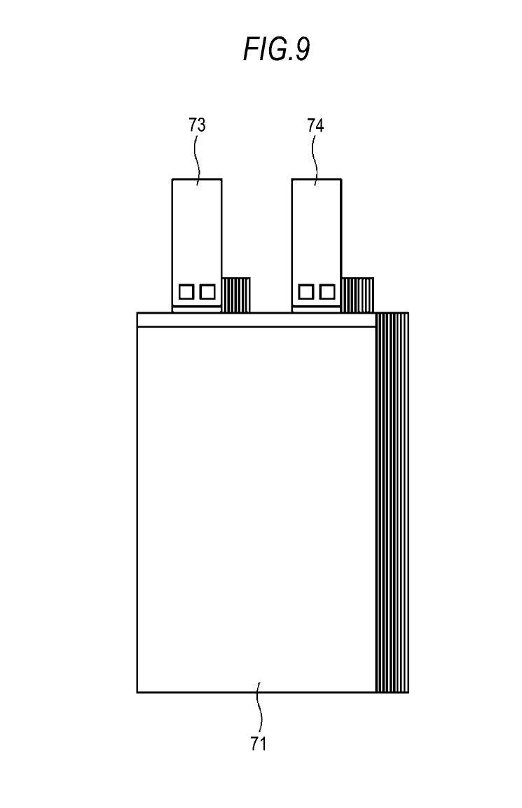

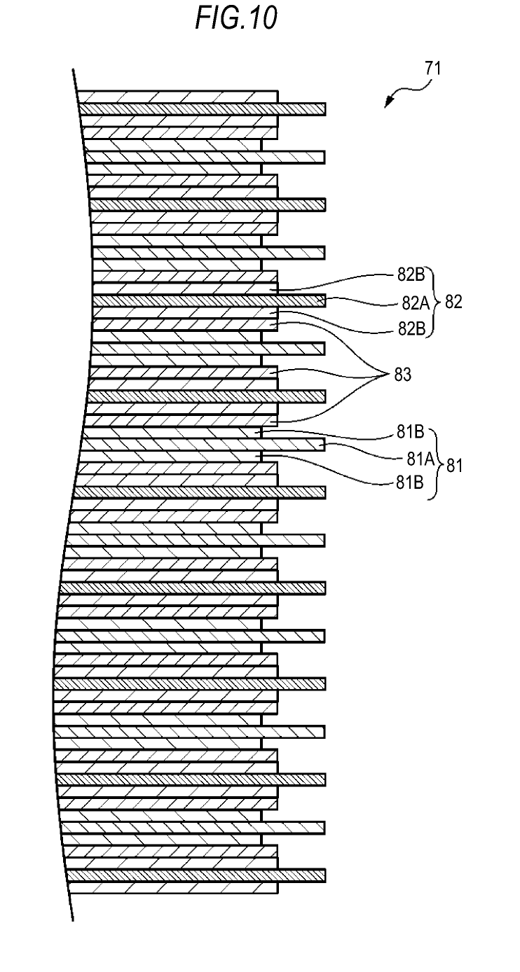

FIG. 9 is a perspective view showing an example of an appearance of the battery device 71. FIG. 10 is a sectional view showing an example of a configuration of the battery device 71. As shown in FIGS. 9 and 10, this battery device 71 is a laminated electrode body in which a positive electrode 81 and a negative electrode 82 are laminated via a separator 83, and the battery device 71 is impregnated with the electrolytic solution according to the first embodiment.

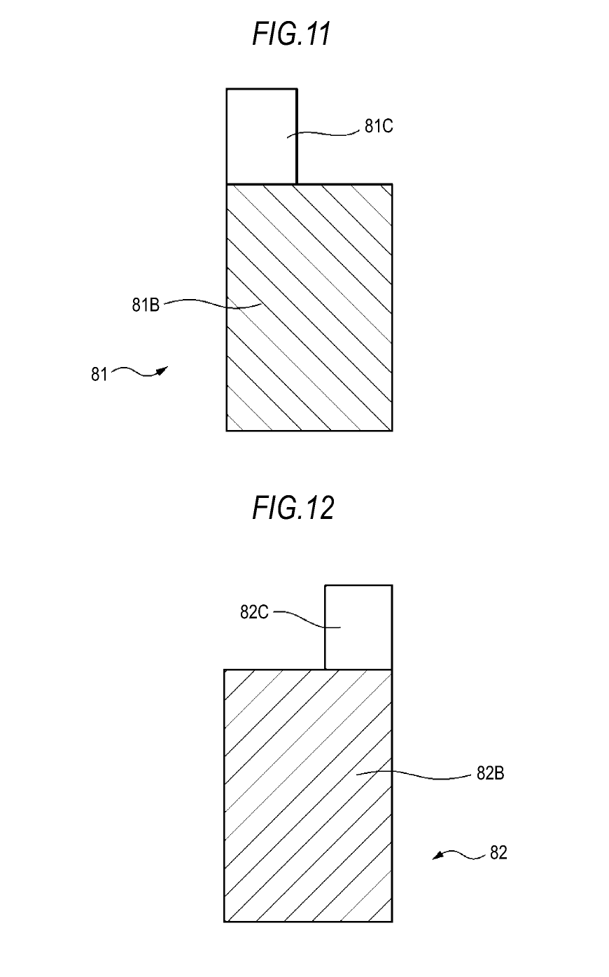

For example, the positive electrode 81 has a structure in which a positive electrode active material layer 81B is provided on the both surfaces of a positive electrode collector 81A having a pair of surfaces. As shown in FIG. 11, the positive electrode 81 has a rectangular electrode portion and a collector-exposed portion 81C extending from one side of the electrode portion. This collector-exposed portion 81C is not provided with the positive electrode active material layer 81B and is in a state where the positive electrode collector 81A is exposed. The collector-exposed portion 81C is electrically connected to the positive electrode lead 73. Incidentally, while illustration is omitted, a region where the positive electrode active material layer 81B is existent only on one surface of the positive electrode collector 81A may be provided.

For example, the negative electrode 82 has a structure in which a negative electrode active material layer 82B is provided on the both surfaces of a negative electrode collector 82A having a pair of surfaces. As shown in FIG. 12, the negative electrode 82 has a rectangular electrode portion and a collector-exposed portion 82C extending from one side of the electrode portion. This collector-exposed portion 82C is not provided with the negative electrode active material layer 82B and is in a state where the negative electrode collector 82A is exposed. The collector-exposed portion 82C is electrically connected to the negative electrode lead 74. Incidentally, while illustration is omitted, a region where the negative electrode active material layer 82B is existent only on one surface of the negative electrode collector 82A may be provided.

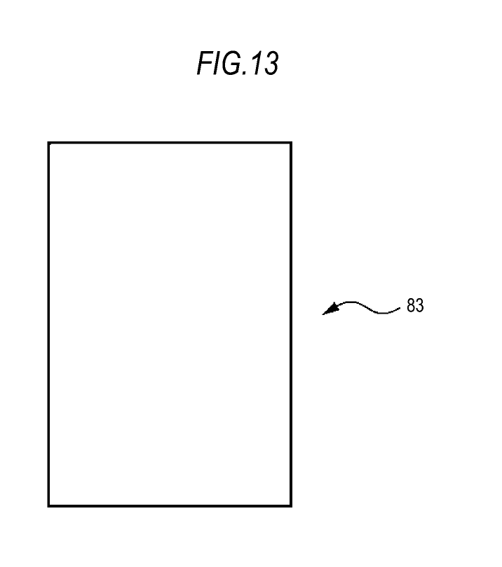

As shown in FIG. 13, the separator 83 has a shape such as a rectangular shape.

Materials constituting the positive electrode collector 81A, the positive electrode active material layer 81B, the negative electrode collector 82A, the negative electrode active material layer 82B and the separator 83 are the same as those in the positive electrode collector 21A, the positive electrode active material layer 21B, the negative electrode collector 22A, the negative electrode active material layer 22B and the separator 23, respectively according to the second embodiment.

Manufacturing Method of Nonaqueous Electrolyte Battery

The thus configured nonaqueous electrolyte battery can be, for example, manufactured in the following manner.

Fabrication of Positive Electrode

The positive electrode 81 is fabricated in the following manner. First of all, for example, a positive electrode active material, a binder and a conductive agent are mixed to prepare a positive electrode mixture, and this positive electrode mixture is dispersed in an organic solvent such as N-methylpyrrolidone to prepare a positive electrode mixture slurry in a paste form. Subsequently, the positive electrode mixture slurry is coated on the both surfaces of the positive electrode collector 81A and dried, followed by pressing to form the positive electrode active material layer 81B. Thereafter, the resultant is cut into the shape shown in FIG. 11, or the like, thereby obtaining the positive electrode 81.

Fabrication of Negative Electrode

The negative electrode 82 is fabricated in the following manner. First of all, for example, a negative electrode active material, a binder and a conductive agent are mixed to prepare a negative electrode mixture, and this negative electrode mixture is dispersed in an organic solvent such as N-methylpyrrolidone to prepare a negative electrode mixture slurry in a paste form. Subsequently, the negative electrode mixture slurry is coated on the both surfaces of the negative electrode collector 82A and dried, followed by pressing to form the negative electrode active material layer 82B. Thereafter, the resultant is cut into the shape shown in FIG. 12, or the like, thereby obtaining the negative electrode 82.

Fabrication of Battery Device

The battery device 71 is fabricated in the following manner. First of all, a polypropylene-made microporous film or the like is cut into the shape shown in FIG. 13, thereby fabricating the separator 83. Subsequently, a plural number of the thus obtained negative electrodes 82, positive electrodes 81 and separators 83 are, for example, laminated in the order of the negative electrode 82, the separator 83, the positive electrode 81, . . . , the positive electrode 81, the separator 83 and the negative electrode 82 as shown in FIG. 10, thereby fabricating the battery device 71.

Subsequently, the collector-exposed portion 81C of the positive electrode 81 is welded to the positive electrode lead 73. Similarly, the collector-exposed portion 82C of the negative electrode 82 is welded to the negative electrode lead 74. Subsequently, after impregnating the electrolytic solution in the battery device 71, the battery device 71 is interposed between the package members 72, and the outer edges of the package members 72 are allowed to adhere to each other by means of heat fusion or the like, thereby sealing the battery device 71 therein. On that occasion, each of the positive electrode lead 73 and the negative electrode lead 74 is disposed so as to come out from the package member 72 via the heat-fused part, thereby forming positive and negative electrode terminals. There is thus obtained the desired nonaqueous electrolyte battery.

Effect

The fifth embodiment has the same effects as those according to the second embodiment according to the present application.

### 6. Sixth Embodiment

Next, a sixth embodiment is described. A nonaqueous electrolyte battery according to this sixth embodiment is one using an electrolyte layer in a gel form in place of the electrolytic solution in the nonaqueous electrolyte battery according to the fifth embodiment. The same portions as those in the fifth embodiment are given the same symbols, and their descriptions are omitted.

Configuration of Nonaqueous Electrolyte Battery

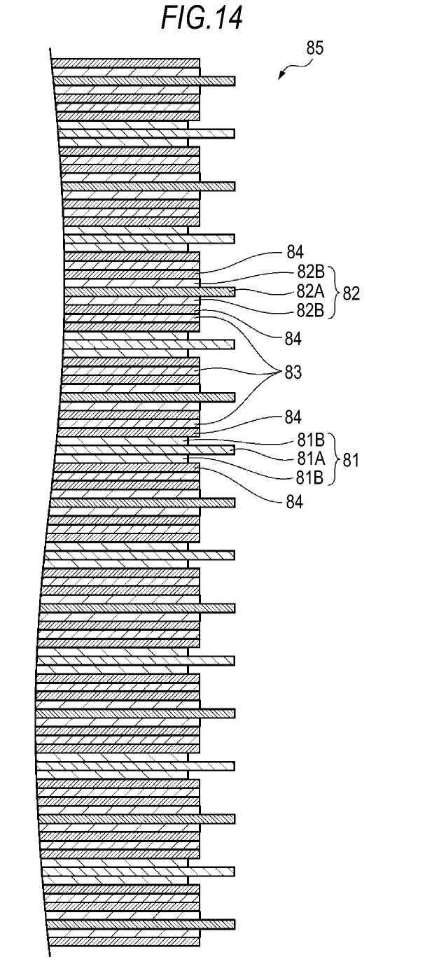

FIG. 14 is a sectional view showing an example of a configuration of a battery device to be used for the nonaqueous electrode secondary battery according to the sixth embodiment. A battery device 85 is one in which the positive electrode 81 and the negative electrode 82 are laminated via the separator 83 and an electrolyte layer 84.

The electrolyte layer 84 contains the electrolytic solution according to the first embodiment and a polymer compound serving as a holding material capable of holding this electrolytic solution therein and takes a so-called gel form. The electrolyte layer 84 in a gel form is preferable because not only a high ion conductivity is obtainable, but liquid leakage of the battery can be prevented from occurring. A constitution of the polymer compound is the same as that in the nonaqueous electrolyte battery according to the third embodiment.

Manufacturing Method of Nonaqueous Electrolyte Battery

The thus configured nonaqueous electrolyte battery can be, for example, manufactured in the following manner.

First of all, a precursor solution containing a solvent, an electrolyte salt, a polymer compound and a mixed solvent is coated on each of the positive electrode 81 and the negative electrode 82, and the mixed solvent is then vaporized to form the electrolyte layer 84. The nonaqueous electrolyte battery can be obtained by following the same subsequent steps as those according to the fifth embodiment, except that the positive electrode 81 and the negative electrode 82 each having the electrolyte layer 84 formed thereon are used.

Effect

The sixth embodiment has the same effects as those according to the fifth embodiment according to the present application.

### EXAMPLES

Examples of the present application are specifically described below, but it should not be construed that the present application is limited to these Examples. In the following description, the mass of the heteropolyacid is defined to be a value obtained by subtracting the mass of bound water which the heteropolyacid has; and the mass of the heteropolyacid compound is defined to be a value obtained by subtracting the mass of bound water which the heteropolyacid compound has.

For the sake of convenience for the description, the following compounds are referred to as Compounds A to K, respectively.

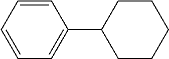

Compound A: Cyclohexylbenzene

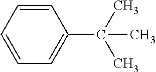

Compound B: tert-Butylbenzene

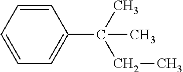

Compound C: tert-Pentylbenzene

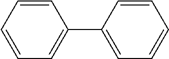

Compound D: Biphenyl

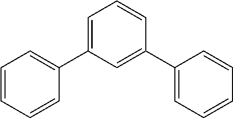

Compound E: m-Terphenyl

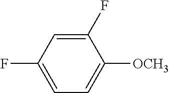

Compound F: 2,4-Difluoroanisole

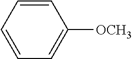

Compound G: Anisole

Compound H: Silicomolybdic acid heptahydrate

Compound I: Silicotungstic acid heptahydrate

Compound J: Phosphomolybdic acid heptahydrate

Compound K: Phosphotungstic acid heptahydrate

### Example 1-1

First of all, 91 parts by mass of lithium cobaltate as a positive electrode active material, 6 parts by mass of graphite as a conductive agent and 3 parts by mass of polyvinylidene fluoride as a binder were mixed, to which was then added N-methylpyrrolidone to obtain a positive electrode mixture slurry. Subsequently, this positive electrode mixture slurry was uniformly coated on the both surfaces of a 12 μm-thick aluminum foil serving as a positive electrode collector, and after drying, the resultant was compression molded by a roll press to form a positive electrode active material layer. Thereafter, a positive electrode lead made of aluminum was installed in an end of the positive electrode collector by means of welding.

Also, 97 parts by mass of an artificial graphite powder as a negative electrode active material and 3 parts by mass of polyvinylidene fluoride as a binder were mixed, to which was then added N-methylpyrrolidone to obtain a negative electrode mixture slurry. Subsequently, this negative electrode mixture slurry was uniformly coated on the both surfaces of a 15 μm-thick copper foil serving as a negative electrode collector, and after drying, the resultant was compression molded by a roll press to form a negative electrode active material layer. Thereafter, a negative electrode lead made of nickel was installed in an end of the negative electrode collector.

Subsequently, the positive electrode, a separator made of a microporous polypropylene film (thickness: 25 μm) and the negative electrode were laminated in this order, the laminate was spirally wound many times, and an end portion of winding was then fixed by an adhesive tape to form a wound electrode body. Subsequently, a nickel-plated iron-made battery can was prepared; the wound electrode body was interposed between a pair of insulating plates; the negative electrode lead was welded to the battery can, and the positive electrode lead was also welded to a safety valve mechanism; and the wound electrode body was housed in the inside of the battery can. Subsequently, an electrolytic solution was injected into the inside of the battery can in a vacuum mode.

As the electrolytic solution, one prepared in the following manner was used. That is, a solution obtained by dissolving 1.2 moles/kg of lithium hexafluorophosphate (LiPF₆) as an electrolyte salt in a mixed solution of ethylene carbonate (EC) and dimethyl carbonate (DMC) in a mass ratio of 3/7 was prepared.

In this connection, Compound A as the aromatic compound and Compound H as the heteropolyacid compound were dissolved in a concentration of Compound A of 0.05% by mass and in a concentration of Compound H of 0.5% by mass, respectively, thereby preparing the electrolytic solution. There was thus fabricated a cylindrical type battery of Example 1-1.

### Example 1-2

A battery was fabricated in the same manner as in Example 1-1, except that on the occasion of preparing the electrolytic solution, the concentration of Compound A was changed to 0.1% by mass.

### Example 1-3

A battery was fabricated in the same manner as in Example 1-1, except that on the occasion of preparing the electrolytic solution, the concentration of Compound A was changed to 0.5% by mass.

### Example 1-4

A battery was fabricated in the same manner as in Example 1-1, except that on the occasion of preparing the electrolytic solution, the concentration of Compound A was changed to 1% by mass, and the concentration of Compound H was changed to 0.01% by mass.

### Example 1-5

A battery was fabricated in the same manner as in Example 1-1, except that on the occasion of preparing the electrolytic solution, the concentration of Compound A was changed to 1% by mass, and the concentration of Compound H was changed to 0.05% by mass.

### Example 1-6

A battery was fabricated in the same manner as in Example 1-1, except that on the occasion of preparing the electrolytic solution, the concentration of Compound A was changed to 1% by mass, and the concentration of Compound H was changed to 0.1% by mass.

### Example 1-7

A battery was fabricated in the same manner as in Example 1-1, except that on the occasion of preparing the electrolytic solution, the concentration of Compound A was changed to 1% by mass.

### Example 1-8

A battery was fabricated in the same manner as in Example 1-1, except that on the occasion of preparing the electrolytic solution, the concentration of Compound A was changed to 1% by mass, and the concentration of Compound H was changed to 1% by mass.

### Example 1-9

A battery was fabricated in the same manner as in Example 1-1, except that on the occasion of preparing the electrolytic solution, the concentration of Compound A was changed to 1% by mass, and the concentration of Compound H was changed to 3% by mass.

### Example 1-10

A battery was fabricated in the same manner as in Example 1-1, except that on the occasion of preparing the electrolytic solution, the concentration of Compound A was changed to 3% by mass.

### Example 1-11

A battery was fabricated in the same manner as in Example 1-1, except that on the occasion of preparing the electrolytic solution, the concentration of Compound A was changed to 5% by mass.

### Example 1-12

A battery was fabricated in the same manner as in Example 1-1, except that on the occasion of preparing the electrolytic solution, the concentration of Compound A was changed to 7.5% by mass.

### Example 1-13

A battery was fabricated in the same manner as in Example 1-1, except that on the occasion of preparing the electrolytic solution, the concentration of Compound A was changed to 1% by mass, and 0.5% by mass of VC (vinylene carbonate) was added.

### Comparative Example 1-1

A battery was fabricated in the same manner as in Example 1-1, except that on the occasion of preparing the electrolytic solution, neither Compound A nor Compound H was added.

### Comparative Example 1-2

A battery was fabricated in the same manner as in Example 1-1, except that on the occasion of preparing the electrolytic solution, neither Compound A nor Compound H was added, and 0.5% by mass of VC was added.

### Comparative Example 1-3

A battery was fabricated in the same manner as in Example 1-1, except that on the occasion of preparing the electrolytic solution, neither Compound A nor Compound H was added, and 1% by mass of VC was added.

### Comparative Example 1-4

A battery was fabricated in the same manner as in Example 1-1, except that on the occasion of preparing the electrolytic solution, neither Compound A nor Compound H was added, and 1% by mass of FEC [fluoroethylene carbonate(4-fluoro-1,3-dioxolan-2-one)] was added.

### Comparative Example 1-5

A battery was fabricated in the same manner as in Example 1-1, except that on the occasion of preparing the electrolytic solution, neither Compound A nor Compound H was added, and 1% by mass of DFEC [difluoroethylene carbonate(4,5-difluoro-1,3-dioxolan-2-one)] was added.

### Comparative Example 1-6

A battery was fabricated in the same manner as in Example 1-1, except that on the occasion of preparing the electrolytic solution, the concentration of Compound A was changed to 0.5% by mass, and Compound H was not added.

### Comparative Example 1-7

A battery was fabricated in the same manner as in Example 1-1, except that on the occasion of preparing the electrolytic solution, the concentration of Compound A was changed to 1% by mass, and Compound H was not added.

### Comparative Example 1-8

A battery was fabricated in the same manner as in Example 1-1, except that on the occasion of preparing the electrolytic solution, Compound A was not added.

### Comparative Example 1-9

A battery was fabricated in the same manner as in Example 1-1, except that on the occasion of preparing the electrolytic solution, Compound A was not added, and the addition amount of Compound H was changed to 1% by mass.

### Comparative Example 1-10

A battery was fabricated in the same manner as in Example 1-1, except that on the occasion of preparing the electrolytic solution, the concentration of Compound A was changed to 0.5% by mass, 1% by mass of DFEC was added, and Compound H was not added.

### Comparative Example 1-11

A battery was fabricated in the same manner as in Example 1-1, except that on the occasion of preparing the electrolytic solution, the concentration of Compound A was changed to 1% by mass, 1% by mass of DFEC was added, and Compound H was not added.

The batteries of Examples 1-1 to 1-13 and Comparative Examples 1-1 to 1-11 were subjected to the following high-temperature cycle test and high-temperature storage test.

High-Temperature Cycle Test

First of all, each of the batteries was subjected to charge/discharge for 2 cycles at a current of 0.2 C in an atmosphere at 23° C., and a discharge capacity at the second cycle was measured. Subsequently, the charge/discharge was repeated for 300 cycles in an atmosphere at 23° C., and a discharge capacity retention rate at the 300th cycle to discharge capacity at the second cycle was determined according to the following expression.

Discharge capacity retention rate(%)={(Discharge capacity at the 300th cycle)/(Discharge capacity at the second cycle)}×100(%)

As to the charge/discharge condition, the battery was subjected to constant-current charge at a current of 0.2 C to an upper limit voltage of 4.2 V and then subjected to constant-voltage charge at a constant voltage of the upper limit voltage until a current value reached 0.05 C, followed by subjecting to constant-current discharge at a current of 0.2 C to a final voltage of 3.0 V. The term “0.2 C” referred to herein is a current value at which a theoretical capacity is completely discharged for 5 hours.

High-Temperature Storage Test

First of all, each of the batteries was subjected to charge/discharge for 2 cycles in an atmosphere at 23° C., and a discharge capacity before storage was measured. Subsequently, the battery was subjected to constant current-constant voltage charge at a current of 0.5 C for 4 hours while setting an upper limit voltage to 4.2 V and stored in a charged state in a thermostat at 60° C. for 10 days. The battery after storage was subjected to constant-current discharge in an atmosphere at 23° C. at a current of 0.2 C to a final voltage of 3.0 V, and a discharge capacity after storage was measured. The high-temperature storage discharge capacity retention rate was calculated according to the following expression.

High-temperature storage discharge capacity retention rate(%)={(Discharge capacity after storage)/(Discharge capacity before storage)}×100(%)

As to the initial charge/discharge condition, the same condition as that in the high-temperature cycle test was applied.

The measurement results are shown in the following Table 1.

TABLE 1

| | | | | | | | High-temperature | High-temperature |
|---|---|---|---|---|---|---|---|---|
| | | | Aromatic compound: | | | | cycle discharge | storage discharge |
| | Cyclic carbonate | | Formula (1) | | Heteropolyacid compound | | capacity retention | capacity retention |
| | Kind | % by mass | Kind | % by mass | Kind | % by mass | rate (%) | rate (%) |
| Example 1-1 | — | — | Compound A | 0.05 | Compound H | 0.5 | 72 | 75 |
| Example 1-2 | | | | 0.1 | | | 73 | 79 |
| Example 1-3 | | | | 0.5 | | | 80 | 86 |
| Example 1-4 | | | | 1 | | 0.01 | 68 | 77 |
| Example 1-5 | | | | | | 0.05 | 72 | 80 |
| Example 1-6 | | | | | | 0.1 | 79 | 86 |
| Example 1-7 | | | | | | 0.5 | 82 | 92 |
| Example 1-8 | | | | | | 1 | 80 | 92 |
| Example 1-9 | | | | | | 3 | 74 | 94 |
| Example 1-10 | | | | 3 | | 0.5 | 84 | 88 |
| Example 1-11 | | | | 5 | | | 80 | 83 |
| Example 1-12 | | | | 7.5 | | | 75 | 80 |
| Example 1-13 | VC | 0.5 | | 1 | | | 84 | 92 |
| Comparative | — | — | — | — | — | — | 63 | 72 |
| Example 1-1 | | | | | | | | |
| Comparative | VC | 0.5 | — | — | — | — | 65 | 72 |
| Example 1-2 | | | | | | | | |
| Comparative | VC | 1 | — | — | — | — | 66 | 71 |
| Example 1-3 | | | | | | | | |
| Comparative | FEC | 1 | — | — | — | — | 65 | 70 |
| Example 1-4 | | | | | | | | |
| Comparative | DFEC | 1 | — | — | — | — | 60 | 80 |
| Example 1-5 | | | | | | | | |
| Comparative | — | — | Compound A | 0.5 | — | — | 68 | 74 |
| Example 1-6 | | | | | | | | |
| Comparative | — | — | | 1 | — | — | 68 | 75 |
| Example 1-7 | | | | | | | | |
| Comparative | — | — | — | — | Compound H | 0.5 | 70 | 75 |
| Example 1-8 | | | | | | | | |
| Comparative | — | — | — | — | | 1 | 73 | 78 |
| Example 1-9 | | | | | | | | |
| Comparative | DFEC | 1 | Compound A | 0.5 | — | — | 63 | 84 |
| Example 1-10 | | | | | | | | |
| Comparative | DFEC | 1 | | 1 | — | — | 64 | 86 |
| Example 1-11 | | | | | | | | |

VC: Vinylene carbonate, FEC: Fluoroethylene carbonate, DFEC: Difluoroethylene carbonate

As shown in Table 1, in Examples 1-1 to 1-13, since the electrolytic solution contains Compound H together with Compound A, the cycle characteristic and storage characteristic at a high temperature were improved as compared with Comparative Example 1-1. On the other hand, in Comparative Examples 1-6 to 1-7, since though the electrolytic solution contains Compound A, it does not contain the heteropolyacid compound, the high-temperature cycle characteristic was not sufficiently enhanced, and the storage characteristic at a high temperature was not sufficiently improved, too. In Comparative Examples 1-8 to 1-9, since though the electrolytic solution contains Compound H, it does not contain the aromatic compound represented by the formula (1), it was difficult to sufficiently enhance the high-temperature cycle characteristic. Also, even when as seen in Comparative Examples 1-10 to 1-11, the electrolytic solution contains Compound A and DFEC that is a highly reactive carbonate, because of a rise of the resistance, it was difficult to sufficiently enhance the high-temperature cycle characteristic. As seen in Examples 1-1 to 1-13, in the case of containing the heteropolyacid compound together with the aromatic compound represented by the formula (1) in the electrolytic solution, the high-temperature cycle characteristic and the high-temperature storage characteristic can be sufficiently improved as compared with the case of containing the heteropolyacid compound or the aromatic compound represented by the formula (1) singly in the electrolytic solution. It may be considered that the deterioration of the battery characteristics is caused due to a side reaction in the both electrodes. On the other hand, when the electrolytic solution contains the heteropolyacid compound together with the aromatic compound represented by the formula (1), the resistance of SEI for protecting the negative electrode becomes small, and at the same time, the decomposition reaction of the aromatic compound represented by the formula (1) on the negative electrode is suppressed, and the original properties of the aromatic compound represented by the formula (1) are sufficiently revealed on the positive electrode. Therefore, excellent battery characteristics can be obtained due to a synergistic effect.

### Example 2-1

A battery was fabricated in the same manner as in Example 1-7, except that on the occasion of preparing the electrolytic solution, Compound A was added in place of Compound H.

### Examples 2-2 to 2-4

Batteries were fabricated in the same manner as in Example 2-1, except that on the occasion of preparing the electrolytic solution, each of Compound I, Compound J and Compound K was added in place of Compound H.

### Examples 2-5 to 2-8

Batteries were fabricated in the same manners as in Examples 2-1 to 2-4, respectively, except that on the occasion of preparing the electrolytic solution, Compound B was added in place of Compound A.

### Examples 2-9 to 2-12

Batteries were fabricated in the same manners as in Examples 2-1 to 2-4, respectively, except that on the occasion of preparing the electrolytic solution, Compound C was added in place of Compound A.

### Examples 2-13 to 2-16

Batteries were fabricated in the same manners as in Examples 2-1 to 2-4, respectively, except that on the occasion of preparing the electrolytic solution, Compound D was added in place of Compound A.

### Examples 2-17 to 2-20

Batteries were fabricated in the same manners as in Examples 2-1 to 2-4, respectively, except that on the occasion of preparing the electrolytic solution, Compound E was added in place of Compound A.

### Examples 2-21 to 2-24

Batteries were fabricated in the same manners as in Examples 2-1 to 2-4, respectively, except that on the occasion of preparing the electrolytic solution, Compound F was added in place of Compound A.

### Examples 2-25 to 2-28

Batteries were fabricated in the same manners as in Examples 2-1 to 2-4, respectively, except that on the occasion of preparing the electrolytic solution, Compound G was added in place of Compound A.

The batteries of Examples 2-1 to 2-28 were subjected to a high-temperature cycle test and a high-temperature storage test in the same manners as in Example 1-1. The test results are shown in the following Table 2.

TABLE 2

| | | | | | High-temperature | High-temperature |
|---|---|---|---|---|---|---|
| | Aromatic compound: | | | | cycle discharge | storage discharge |
| | Formula (1) | | Heteropolyacid compound | | capacity retention | capacity retention |
| | Kind | % by mass | Kind | % by mass | rate (%) | rate (%) |
| Example 2-1 | Compound A | 1 | Compound H | 0.5 | 82 | 92 |
| Example 2-2 | | | Compound I | | 82 | 93 |
| Example 2-3 | | | Compound J | | 80 | 91 |
| Example 2-4 | | | Compound K | | 81 | 91 |
| Example 2-5 | Compound B | 1 | Compound H | | 84 | 93 |
| Example 2-6 | | | Compound I | | 85 | 93 |
| Example 2-7 | | | Compound J | | 83 | 92 |
| Example 2-8 | | | Compound K | | 83 | 92 |
| Example 2-9 | Compound C | 1 | Compound H | | 85 | 93 |
| Example 2-10 | | | Compound I | | 85 | 94 |
| Example 2-11 | | | Compound J | | 82 | 92 |
| Example 2-12 | | | Compound K | | 83 | 92 |
| Example 2-13 | Compound D | 1 | Compound H | | 80 | 88 |
| Example 2-14 | | | Compound I | | 81 | 88 |
| Example 2-15 | | | Compound J | | 77 | 86 |
| Example 2-16 | | | Compound K | | 78 | 86 |
| Example 2-17 | Compound E | 1 | Compound H | | 78 | 85 |
| Example 2-18 | | | Compound I | | 80 | 86 |
| Example 2-19 | | | Compound J | | 75 | 83 |
| Example 2-20 | | | Compound K | | 79 | 83 |
| Example 2-21 | Compound F | 1 | Compound H | | 83 | 89 |
| Example 2-22 | | | Compound I | | 84 | 91 |
| Example 2-23 | | | Compound J | | 82 | 88 |
| Example 2-24 | | | Compound K | | 82 | 88 |
| Example 2-25 | Compound G | 1 | Compound H | | 78 | 86 |
| Example 2-26 | | | Compound I | | 80 | 86 |
| Example 2-27 | | | Compound J | | 77 | 83 |
| Example 2-28 | | | Compound K | | 77 | 84 |

As shown in Table 2, in Examples 2-1 to 2-28, since the electrolytic solution contains the heteropolyacid compound such as Compound H, Compound I, Compound J or Compound K together with the aromatic compound represented by the formula (1) such as Compound A, Compound B, Compound C, Compound D, Compound E, Compound F or Compound G, the cycle characteristic and storage characteristic at a high temperature were sufficiently improved as compared with Comparative Example 1-1. Also, in Examples 2-5 to 2-12, the cycle characteristic and storage characteristic at a high temperature could be more improved. This is because the electrolytic solution contains an aromatic compound having an alkyl group in which carbon directly bonded to the aromatic group is quaternary, and this aromatic compound is hardly subjected to an oxidation-reduction reaction as compared with other aromatic compounds. Also, in the case of using an electrolytic solution containing silicomolybdic acid or silicotungstic acid, the cycle characteristic and storage characteristic at a high temperature could be more improved as compared with the case of using an electrolytic solution containing phosphomolybdic acid or phosphotungstic acid. It may be considered that this was caused due to the fact that the silicon-containing heteropolyacid compound has a higher protective action against the electrode as compared with the phosphorus-containing heteropolyacid compound.

### 7. Other Embodiments

It should not be construed that the present application is limited to the foregoing embodiments, and various modifications and applications can be made therein so far as the gist of the present application is not deviated.

For example, in the foregoing embodiments and working examples, the batteries having a laminated film type or cylindrical type battery structure, the batteries having a wound structure in which the electrodes are wound and the batteries of a stack type having a structure in which the electrodes are stacked have been described, but it should not be construed that the present application are limited thereto. For example, the present application can be similarly applied to batteries having other battery structure such as a rectangular type, a coin type and a button type, and the same effects can be obtained.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A nonaqueous electrolyte comprising:
a solvent;
an electrolyte salt;
an aromatic compound represented by the following formula (1); and
a polyoxometalate and/or a polyoxometalate compound 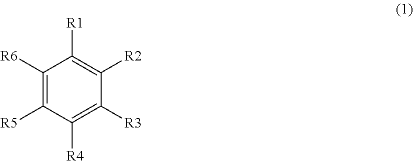
wherein
each of R1 to R6 independently represents a hydrogen group, a halogen group, an aliphatic alkyl group, an alicyclic alkyl group, a phenyl group or an alkoxy group;
at least one of R1 to R6 is a halogen group, an aliphatic alkyl group, an alicyclic alkyl group, a phenyl group or an alkoxy group;
a part or all of hydrogens of R1 to R6 may be substituted with a halogen; and
at least a part of R1 to R6 may be bonded to each other to form a ring.

2. The nonaqueous electrolyte according to claim 1, wherein the polyoxometalate and/or the polyoxometalate compound is a heteropolyacid and/or a heteropolyacid compound.

3. The nonaqueous electrolyte according to claim 2, wherein the heteropolyacid and/or the heteropolyacid compound is a compound represented by the following formula (I)
Aₓ[BD₁₂O₄₀].yH₂O Formula (I)
wherein
a represents H, Li, Na, K, Rb, Cs, Mg, Ca, Al, NH₄, a quaternary ammonium salt or a phosphonium salt; B represents P, Si, As or Ge; D represents at least one element selected from the group consisting of Ti, V, Cr, Mn, Fe, Co, Ni, Cu, Zn, Ga, Zr, Nb, Mo, Tc, Rh, Cd, In, Sn, Ta, W, Re and Tl; and x and y are values falling within the ranges of (0≦x≦7) and (0≦y≦50), respectively.

4. The nonaqueous electrolyte according to claim 2, wherein the heteropolyacid and/or the heteropolyacid compound is a heteropolyacid and/or a heteropolyacid compound, each of which contains silicon.

5. The nonaqueous electrolyte according to claim 1, wherein the polyoxometalate and/or the polyoxometalate compound is a heteropolyacid and/or a heteropolyacid compound, each of which contains two or more addenda atoms.

6. The nonaqueous electrolyte according to claim 1, wherein the aromatic compound represented by the formula (1) is an aromatic compound represented by the following formula (2) or an aromatic compound represented by the following formula (3) 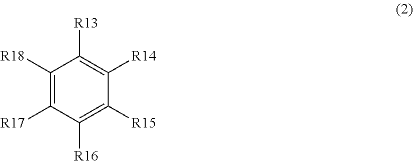
wherein
R13 represents an aliphatic alkyl group, an alicyclic alkyl group or a phenyl group;
a part or all of hydrogens of R13 may be substituted with a halogen; and
each of R14 to R17 independently represents a hydrogen group or a halogen group, and 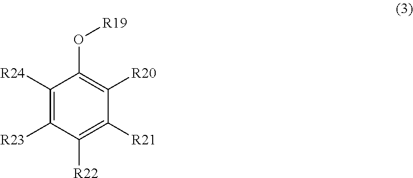
wherein
R19 represents an aliphatic alkyl group, an alicyclic alkyl group or a phenyl group;
a part or all of hydrogens of R19 may be substituted with a halogen; and
each of R20 to R24 independently represents a hydrogen group or a halogen group.

7. The nonaqueous electrolyte according to claim 1, wherein the aromatic compound represented by the formula (1) is an aromatic compound represented by the following formula (4) 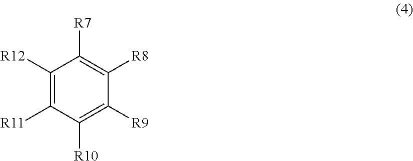
wherein
R7 represents a tertiary alkyl group, a quaternary alkyl group, a phenyl group or an alkoxy group;
a part or all of hydrogens of R7 may be substituted with a halogen; and
each of R8 to R12 independently represents a hydrogen group or a halogen group.

8. The nonaqueous electrolyte according to claim 1, wherein a content of the polyoxometalate and/or the polyoxometalate compound is 0.01% by mass or more and not more than 3% by mass.

9. The nonaqueous electrolyte according to claim 1, wherein a content of the aromatic compound represented by the formula (1) is 0.1% by mass or more and not more than 5% by mass.

10. A nonaqueous electrolyte battery comprising:
a positive electrode,
a negative electrode; and
a nonaqueous electrolyte containing a solvent and an electrolyte salt, wherein
the nonaqueous electrolyte contains an aromatic compound represented by the following formula (1); and
a coating in a gel form containing an amorphous polyoxometalate and/or polyoxometalate compound having one or more heteroatoms is formed on the negative electrode 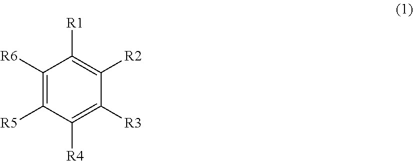
wherein
each of R1 to R6 independently represents a hydrogen group, a halogen group, an aliphatic alkyl group, an alicyclic alkyl group, a phenyl group or an alkoxy group;
at least one of R1 to R6 is a halogen group, an aliphatic alkyl group, an alicyclic alkyl group, a phenyl group or an alkoxy group;
a part or all of hydrogens of R1 to R6 may be substituted with a halogen; and
at least a part of R1 to R6 may be bonded to each other to form a ring.

11. The nonaqueous electrolyte battery according to claim 10, wherein the coating in a gel form is one obtained from the amorphous polyoxometalate and/or polyoxometalate compound deposited so as to have a three-dimensional network structure upon absorbing an electrolytic solution therein.

12. The nonaqueous electrolyte battery according to claim 10, wherein the nonaqueous electrolyte is an electrolyte in a gel form obtained when a polymer compound is gelled upon absorbing an electrolytic solution containing the solvent and the electrolyte salt.

13. A nonaqueous electrolyte battery comprising:
a positive electrode;
a negative electrode; and
a nonaqueous electrolyte, wherein
the nonaqueous electrolyte contains
a solvent,
an electrolyte salt,
an aromatic compound represented by the following formula (1), and
a polyoxometalate and/or a polyoxometalate compound 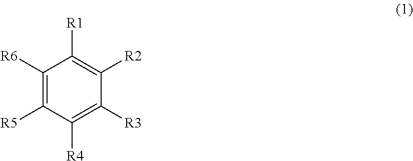
wherein
each of R1 to R6 independently represents a hydrogen group, a halogen group, an aliphatic alkyl group, an alicyclic alkyl group, a phenyl group or an alkoxy group;
at least one of R1 to R6 is a halogen group, an aliphatic alkyl group, an alicyclic alkyl group, a phenyl group or an alkoxy group;
a part or all of hydrogens of R1 to R6 may be substituted with a halogen; and
at least a part of R1 to R6 may be bonded to each other to form a ring.
